(19) United States
(12) Patent Application Publication
(10) Pub. No.: US 2025/0371192 A1
(43) Pub. Date: Dec. 4, 2025

(54) SYSTEMS AND METHODS FOR CONTROLLING AND VALIDATING ARTIFICIAL INTELLIGENCE MODEL INFERENCING AND OUTPUTS

(71) Applicant: Prediction Guard, Inc., Lafayette, IN (US)

(72) Inventor: Daniel Lee Whitenack, Lafayette, IN (US)

(21) Appl. No.: 18/812,370

(22) Filed: Aug. 22, 2024

Related U.S. Application Data
(60) Provisional application No. 63/534,103, filed on Aug. 22, 2023.
(60) Provisional application No. 63/655,552, filed on Jun. 3, 2024.

(51) Int. Cl. G06F 21/62

(52) U.S. Cl. CPC G06F 21/6254

(57) ABSTRACT

A device may receive, via one or more processors, user input including a text prompt string. A device may process, via one or more processors, the text prompt string to generate a sanitized text prompt string. A device may receive a text output string corresponding to processing of the sanitized text prompt string using the one or more language models. A device may process, via one or more processors, the text output string to generate a sanitized text output string. A device may cause, via the one or more processors, the sanitized text output string to be transmitted via an electronic network.

### CROSS-REFERENCE TO RELATED APPLICATIONS

The present application claims the priority benefit of U.S. Provisional Pat. App. No. 63/534,103, entitled “METHODS AND SYSTEMS FOR PRIVACY-CENTRIC DATA FILTERING, SENSITIVE PROMPT CENSORSHIP, AND ALIGNMENT OF MACHINE LEARNING MODELS,” and filed Aug. 22, 2023, and U.S. Provisional Pat. App. No. 63/655,552, entitled “METHODS AND SYSTEMS FOR PRIVACY-CENTRIC DATA FILTERING, SENSITIVE PROMPT CENSORSHIP, AND ALIGNMENT OF MACHINE LEARNING MODELS,” and filed Jun. 3, 2024, the disclosures of each of which are incorporated by reference herein.

### FIELD OF THE DISCLOSURE

The present disclosure generally relates to the integration of artificial intelligence (AI), machine learning (ML), and other predictive models on personal computers, mobile devices, and/or edge devices; and more particularly, to techniques enabled by controlled and validated implementations of machine learning models.

### BACKGROUND

Integrations of generative AI models, such as large language models (LLMs), involve providing a text prompt as input to the model and receiving an output based on that prompt (e.g., a completion, a prediction, an answer, etc.) as output. For businesses that are risk averse or privacy sensitive, these interactions open up prohibitive possibilities for unreliability, user harm, liability, and/or breaches of compliance. Such AI models are known to hallucinate inaccurate information, produce unacceptable variances in output, or merely provide unhelpful text blobs as output.

Moreover, some AI models, including state-of-the-art LLMs, may require the user to send their private data to a third party application programming interface (API). This API usage complicates maintaining privacy and compliance, especially when the third party has unclear terms of service that might result in leaks of sensitive user data.

Therefore, there are opportunities for improved platforms and technologies for controlled and validated interactions with one or more predictive language models, to detect, avoid and/or mitigate risks to computing systems and user data.

### BRIEF SUMMARY

In some aspects, the techniques described herein relate to a computer-implemented method for controlled and validated interactions with one or more predictive language models, the method including: receiving, via one or more processors, user input including a text prompt string; processing, via one or more processors, the text prompt string to generate a sanitized text prompt string; receiving a text output string corresponding to processing of the sanitized text prompt string using the one or more language models; processing, via one or more processors, the text output string to generate a sanitized text output string; and causing, via the one or more processors, the sanitized text output string to be transmitted via an electronic network.

In some aspects, the techniques described herein relate to a computing system for controlled and validated interactions with one or more predictive language models, including: one or more processors; one or memories having stored thereon computer-executable instructions that when executed cause the computing system to: receive, via the processors, user input including a text prompt string; process, via the processors, the text prompt string to generate a sanitized text prompt string; receive a text output string corresponding to processing of the sanitized text prompt string using the one or more language models; process, via the processors, the text output string to generate a sanitized text output string; and cause, via the processors, the sanitized text output string to be transmitted via an electronic network.

In some aspects, the techniques described herein relate to a computer readable medium having stored thereon computer-executable instructions that when executed cause a computer to: receive, via the processors, user input including a text prompt string; process, via the processors, the text prompt string to generate a sanitized text prompt string; receive a text output string corresponding to processing of the sanitized text prompt string using the one or more language models; process, via the processors, the text output string to generate a sanitized text output string; and cause, via the processors, the sanitized text output string to be transmitted via an electronic network.

In some aspects, the techniques described herein relate to a computer readable medium having stored thereon computer-executable instructions that when executed cause a computer to identify sensitive, private, or harmful data in the text prompt string.

In some aspects, the techniques described herein relate to a computer readable medium having stored thereon computer-executable instructions that when executed cause a computer to align the predictive model-generated outputs with the user-provided knowledge base.

In some aspects, the techniques described herein relate to a computer readable medium having stored thereon computer-executable instructions that when executed cause a computer to identify task-specific information from user input text prompts and generate task-specific templates by customizing the predictive model

In some aspects, the techniques described herein relate to a computer readable medium having stored thereon computer-executable instructions that when executed cause a computer to facilitate the concurrent chaining of multiple generative AI or model inferences, constructing responses for the client application from the API application while applying controls in parallel during the chaining of multiple model inferences.

In some aspects, the techniques described herein relate to a computer readable medium having stored thereon computer-executable instructions that when executed cause a computer to: receive the user input and pair it with the text prompt string when processing the text prompt to generate the sanitized text prompt string using the one or more language models.

### BRIEF DESCRIPTION OF THE DRAWINGS

The figures described below depict various aspects of the system and methods disclosed herein. It should be understood that each figure depicts an aspect of a particular aspect of the disclosed system and methods, and that each of the figures is intended to accord with a possible aspect thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 is a system architecture diagram of an exemplary server device application, showing interaction between a server and remote client and datastore, according to an aspect;

FIG. 2, presents an alternative implementation of FIG. 1, according to an aspect;

FIG. 3 is a block diagram of a secure processing architecture where user data is encrypted, processed within a Trusted Execution Environment (TEE) on a server, and managed by an API to ensure data remains protected within a secure enclave, according to an aspect;

FIG. 4 is a block diagram of a system architecture that may be used to deploy and maintain the integrity of an API Application within a secure server environment. The architecture includes mechanisms for collecting environmental data via a dedicated module and transmitting this data to a Trust Authority or external verification, according to an aspect;

FIG. 5 is block diagram depicting a system 500 that may be used for optimizing and deploying LLMs across various hardware platforms, such that the models may be tailored to the unique characteristics of each processor type and may deliver improved performance during execution, according to an aspect.

FIG. 6 is a method diagram of exemplary model's process of evaluating and handling user input for safety, according to an aspect;

FIG. 7 is a method diagram of an exemplary model's process of evaluating and handling user input for sensitive information, according to an aspect;

FIG. 8 is a method diagram of an exemplary system's consistency sampler, which iteratively invokes designated models via model applications, employing methods like self-consistency sampling and amalgamating outputs from multiple inferences through statistical or model-based approaches, yielding final output, according to an aspect;

FIG. 9 is a method diagram of an exemplary model receiving of a user's task request, followed by retrieval and compilation of a model/task-specific prompt, which is then used by one or more models, with the receiving model responding by delivering the task response to the user, according to an aspect;

FIG. 10 is a method diagram of an exemplary model's process of categorizing user prompts for privacy, directing non-sensitive ones to a privacy-focused model and sensitive ones to a third-party API, to provide corresponding responses, according to an aspect;

FIG. 11 is a method diagram of an exemplary model's process of handling user requests, domain/task identification, model selection through functionality tests, prompt transmission, model response reception, and user response generation, according to an aspect;

FIG. 12 is a block diagram of an exemplary sequence of prompt reception, control parameter application, response decoding within constraints, validation, and reply generation based on the model's output, according to an aspect;

FIG. 13 is a block diagram of receiving user prompt and control parameters, which are forwarded to one or more model applications with control instructions, followed by receiving a model response, validating that response against the control parameters, and finally constructing and sending a user response based on the prompt and model responses, according to an aspect;

FIG. 14 is an exemplary diagram of a user input embedded within an API request, consisting of an instruction and accompanying prompt, according to an aspect;

FIG. 15 is a method diagram of an exemplary safeguarding mechanism for an automated system that generates responses to user prompts, ensuring that sensitive information is detected and handled appropriately before any response is generated, according to an aspect;

FIG. 16 is a block diagram from user prompt to factuality-scored response delivery, according to an aspect;

FIG. 17 is a block diagram from user prompt to toxicity-scored response delivery, according to an aspect;

FIG. 18A is a block diagram from user prompt to quality-scored response delivery, according to an aspect;

FIG. 18B is a block diagram of a method for end-to-end encrypted AI model execution, where encrypted prompts are received from a client, processed by models like Llama 3 or Mistral without decryption, and returned as encrypted outputs to the client for decryption.

FIG. 19 is an exemplary command line interface setup where an API Application mediates between varied LLMs and a Terminal Prompt, with Controls for model selection and accuracy, Constraints for input-output sorting, and an LLM Output indicating sentiment classification, according to an aspect;

FIG. 20 is a block flow diagram of a user-centric AI workflow diagram where sensitive data is processed through a Python and REST API-driven system, interfacing with models to ensure outputs are reliable and compliant with legal, security, and financial standards, indicated by positive emojis, in an open structure, according to an aspect;

FIG. 21 is a block flow diagram of an exemplary system architecture diagram for a CLI-based environment utilizing various language models to process data under constraints and produce structured outputs, comprising a command Playground, a visual output App UI, REST API and Python client for interaction, a central processing Server, dedicated language model Applications, and several GPUs for optimized processing, all configured for flexible and scalable operations such as text generation and language translation, according to an aspect;

FIG. 22 is a high-level overview schematic of an exemplary processing infrastructure, outlining the sequence from initial user prompt input through various security and quality checks, resulting in user response output, according to an aspect;

FIG. 23 is a block flow diagram of an exemplary general infrastructure for API-driven interactions, where a client application requests services from a cloud or on-premise system, which process the data through a model inference system and accesses a datastore for authentication and usage tracking, according to an aspect;

FIG. 24, presents an alternative implementation of FIG. 23, according to an aspect;

FIG. 25 is an AI Infrastructure framework, of an exemplary AI application's infrastructure with interactive demos, API interfacing, integration of custom LLMs, and capabilities for model training, experimentation, data management, and consistent output generation, according to an aspect;

FIG. 26 is an exemplary graphical user interface for input/output, with enabled model selection, and activated toxicity safeguard, according to an aspect;

FIG. 27 is an alternative visualization of the graphical user interface shown in FIG. 26, including enabling of “type constraints”, specifically datatype integer, to constrain model output generation, according to an aspect;

FIG. 28 is an alternative visualization of the graphical user interface shown in FIG. 27, now demonstrating activation of the consistency safeguard, according to an aspect;

FIG. 29 is a Python code example using the “prediction guard” library to categorize text prompts, configuring environmental variables for authentication, defining the input prompt, invoking a text classification model, and outputting the results in a readable JSON format with sorted keys and indented structure, according to an aspect;

FIG. 30 is a Python code example demonstrating use of the “factual consistency check” function within the prediction guard library, with the necessary bindings, which evaluates the factuality of user inputs, and returns verification results, according to an aspect;

FIG. 31 is a Python code example demonstrating use of the “toxicity check” function within the prediction guard library, with the necessary bindings, to evaluate and handle toxic content within user inputs, according to an aspect;

FIG. 32 is a Python code example that ensures LLM output consistency by setting the ‘consistency’ parameter to ‘true’ in the ‘output’ field of the prediction guard function, guaranteeing uniform LLM results, according to an aspect;

FIG. 33 is a Python code example of a model's ability to detect and intercept hallucinations, upon which it returns error status to user, according to an aspect;

FIGS. 34-36 are Python code examples of a model's ability to ensure LLM outputs conform to specific primitive data types, such as valid integers (FIG. 34), floating-point numbers (FIG. 35), and Booleans (FIG. 36), according to an aspect;

FIG. 37 is a Python code example of a model's ability to constrain LLM outputs to user-specified categorical outputs, according to an aspect;

FIG. 38 is a Python code example of a model's capability to constrain LLM outputs to non-primitive datatypes, user-defined data structures, incorporating JSON and object-type constraints, according to an aspect;

FIG. 39 illustrates an exemplary user-provided JSON Schema defining the desired format for the model's output, according to an aspect;

FIG. 40 presents an exemplary graphical user interface of the “Chat Playground” with enabled model selection, a defined number of tokens, and activated toxicity safeguard, all available for user interaction, according to an aspect;

FIG. 41 illustrates a block flow diagram of a process from the entry of a user prompt to an output of the prompt from an LLM using the techniques provided herein, according to an aspect; and

FIG. 42 illustrates several examples of possible ways to host an LLM and API using the techniques provided herein, according to an aspect.

The figures depict preferred embodiments for purposes of illustration only. Alternative embodiments of the systems and methods illustrated herein may be employed without departing from the principles of the invention described herein.

### DETAILED DESCRIPTION

The present disclosure describes systems and methods for controlling and validating artificial intelligence (AI) and machine learning (ML), and more generally any predictive model, inference and corresponding outputs. Generally, the present techniques may include all or a subset of model input filters, model output validations, model input modifications, model output modifications, custom model decoding techniques, prompt templating, sensitive/harmful data detection, factuality detection, toxicity detection, self-consistency sampling, prompt chaining, automated model selection, type checking, output alignment with a user-provided knowledge base and/or model ensembling to enable controlled and validated interactions with predictive models. The combination of input/output modifications along with various checks, templating, filtering, and validations may advantageously improve LLM-based systems by allowing client devices to serve safe, private, and trustworthy AI-driven interactions within applications (e.g., client applications).

The present techniques may include processing (also referred to as “sanitizing” herein) input text prompts or other modalities of inputs to models (hereinafter referred to generally as user input) through multiple data processing steps that include multiple AI models and/or machine learning (ML) models. The present techniques may include multiple data processing steps involving near deterministic or rules-based logic. These multiple data processing steps may be executed in various ways depending on sensitive, private, or harmful data detections in the input to models and factuality, toxicity, type, structure, or consistency detections in model outputs.

The exact flow of the user input through the data processing steps may be controlled on-the-fly (e.g., during runtime of an LLM system) for each user input or subsets of user inputs based on the various sensitive, private, or harmful data detections in the input to models and factuality, toxicity, type, structure, or consistency detections in model outputs. In this manner, the performance of the predictive model inference and outputs may be increased (e.g., as measured by a percentage of hallucinations, a percentage of harmful outputs, or a percentage of unexpected output structures) by using controlled and validated predictive model interactions rather than raw model outputs.

In addition, these systems and methods may allow for the resource consumption and response latency of client devices to be optimized by, inter alia, decoding only validated outputs from predicted models (i.e., rather than any open domain outputs), restricting model outputs to certain structures, concurrently calling ensembles of models (i.e., rather than calling them sequentially or individually), automating the filtering of or selection of certain models based on detected or user-defined constraints, automating fallback model inferences based on model failures, optimizing the execution of the model interface on specialized hardware, and preventing complicated and costly logic to wrap and parse the raw text output from predictive models.

### Exemplary System

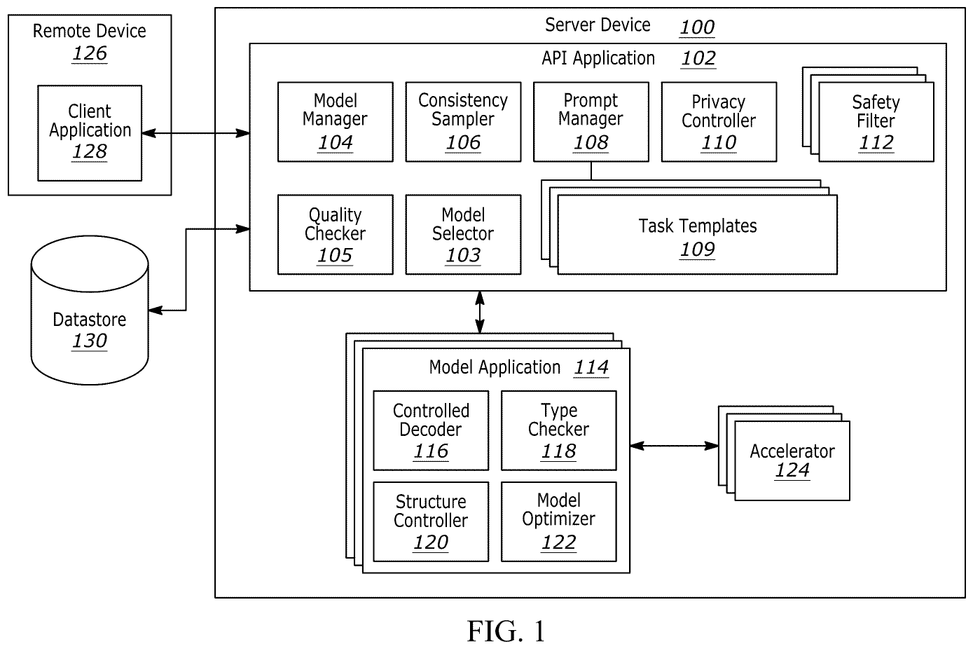

FIG. 1 presents a system architecture of a model server device 100, which interfaces with a remote client device 126 and a datastore 130. The remote device 126 stores the client application 128, while the server device stores an API application 102, a model application 114, and an accelerator 124. The API application 102 stores several modules, including a model manager 104, a consistency sampler 106, a prompt manager 108, a privacy controller 110, a safety filter 112, a quality checker 105, a model selector 103, and one or more task templates 109. The model application 114 includes the controlled decoder 116, type checker 118, structure controller 120 and model optimizer 122.

FIG. 1 shows an example server device 100 running the API application 102 to enable controlled and validated artificial intelligence inference and outputs. The server device 100 need not be a virtual machine in cloud infrastructure, but the server device 100 could be any computer device configured to enable controlled and validated interactions with AI models (such as LLMs).

In one implementation, a user of the controlled and validated predictive modeling functionality is a server device, such as a cloud or on-premises servers, hosting a client application that makes use of predictions (or inferences) from AI or predictive models. The exemplary client application may enable chat, content generation, question answering, summarization, rephrasing, translation, sentiment analysis, text classification or other similar interactive interactions with users via one or more graphical or text user interfaces. The exemplary client application may also enable non-interactive and/or batch processing of data used to automate business operations, decision making, alerting, text translation, content production, or other similar business automations.

Remote device 126 is equipped with computer-executable instructions to enable remote interfacing. The remote device 126, adaptable as smartphones, tablets, laptops, or any digital device capable of network communication, sends requests to and receives responses from the API application 102. Users or systems operating from the remote device 126 can initiate a variety of requests, such as initiating data model processes, retrieving information, or specifying system operation parameters. For example, the API application 102 may be configured to respond to requests from and/or stream information to a client application 128 running on a remote device 126 via a rest or other relevant API protocol. for example, the server device 100 may communicate with the client application 128 over HTTP using JSON request and response bodies.

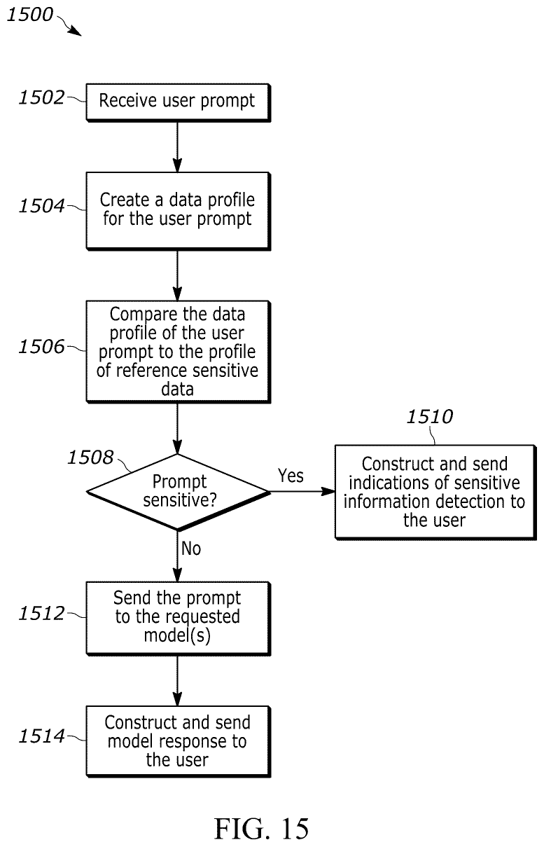

The exemplary client application 128 enables the predictions (or inferences) from AI or predictive models via a language client (e.g., Python) or REST API client, which client connects to the API application 102. In many scenarios, the client application 128 may use generative AI prompting techniques, via the API application 102, to enable its functionality. In these scenarios, the client application 128 provides a text prompt (see, for example, 1402 and 1404 of FIG. 14) as part of a request to the API application 102, and the API application 102 (along with the control and validation techniques described below) responds with the output (see, for example 1406 of FIG. 14) of one or more models (e.g., LLMs) resulting from them being provided the text prompt as input.

The datastore 130 serves as a specialized repository configured to support the operations of the system. The datastore 130 may be implemented as a standalone database or integrated within a larger data management system, employing any suitable data management techniques. The datastore 130 may be a relational database Oracle, DB2, MySQL, or NoSQL frameworks such as MongoDB, or any other suitable database. Moreover, within datastore 130, data may be systematically organized into schemas, tables, collections, or documents to store user interactions and metadata, allowing for the maintenance of complex data relationships and enabling advanced data analysis and the enhancement of machine learning algorithms. The datastore 130 may store data used to train and/or operate one or more interactive content models. The datastore 130 may store runtime data (e.g., a task flow document received via the network, etc.).

The API application 102 (or just API) is a set of executable instructions (software) for facilitating access to data or some other operational aspect (e.g., controlling/accessing/querying) data. The API runs various sensitive, private, or harmful data detections on the input to models and factuality, toxicity, type, structure, or consistency detections in model outputs. The exemplary models themselves are connected to the API application 102 via other REST API endpoints or other appropriate API contracts.

The model selector 103 module may include a set of computer-executable instructions for utilizing an appropriate task and/or set of models that should be called. For example, the model selector 103 may utilize one of the models available via the model applications 114 to process the request from the client application 128 and determine that the request is requesting a certain task (e.g., summarization). Based on this request intent, the model selector 103 may select a subset of the models available in the model applications 114 that perform best on the detected task, and/or the model selector 103 may communicate with the prompt manager 108 to configure calls to one or more of the model available in the model applications 114.

The model manager 104 module may include computer-executable instructions to manage the delegation and validation of text prompts from the client application 128 to the model application 114. This module ensures that outgoing prompts are correctly routed within the API application 102. For example, when the client manager 128 specifies the use of particular models for corresponding to text prompts, the model manager 104 may consult with a registry to locate the necessary information (e.g., URL or Domain), of the appropriate model applications 114.

The quality checker 105 module may include a set of computer-executable instructions for appraising the standard of LLM-generated content through various quality measures. This module scrutinizes the inputs/outputs of the model applications 114, evaluating them against established criteria to ascertain their adequacy for further automated processes, which may involve ML, deep learning, or other AI techniques. The quality checker ensures the outputs meet certain predetermined standards, such as clarity, factual accuracy, factual consistency, or the absence of toxicity.

The consistency sampler 106 module may include computer-executable instructions that enable it to manage and verify the consistency of outputs from the AI models within model applications 114, as dictated by requests from client application 128. This module is responsible for invoking the specified models multiple times, if necessary, to procure a variety of results. The objective is to assess and ensure a uniform standard of output by employing self-consistency sampling techniques, where it compares the various results for consistency. For example, consistency sampler 106 may use semantic similarity measures with embeddings, Levenstein distance, edit distance, or other suitable metrics to evaluate the agreement among the results obtained from model applications 114. Should the output variability exceed the set thresholds of consistency sampler 106, API application 102 is prompted to communicate the inconsistency through error messages or specific indicators to the user. Additionally, this module has the capability to synthesize and reconcile the gathered outputs, potentially utilizing another LLM call for an integrated and coherent result. This ensures that the responses provided to the user are not only consistent in terms of content but also in line with the expectations set by the request.

The prompt manager 108 module may include computer-executable instructions to establish a bidirectional relationship between the API application 102 and model application 114. The prompt manager processes structured outputs received from API application 102, and in turn, provides AI-generated outputs from Model Outputs back to it. For example, when API application 102 sends a request for a language translation task, model application 114 receives the prompt, activates the specific translation model.

The prompt manager 108 may include a set of computer-executable instructions to manage the conversion of user or system-initiated requests from API application 102 into structured prompts for AI models within model applications 114. This module processes the requests and formulates prompts that are syntactically compatible with the AI models' processing capabilities. For example, if a user request involves natural language processing, prompt manager 108 structures the prompt to fit the expected input format of the relevant language processing model (e.g., ChatML or Alpaca). The functionality of prompt manager 108 includes interpreting the context of user requests and the operational parameters of the AI models to create prompts that are clear and direct, thereby facilitating precise model execution. It ensures that the prompts sent to model applications 114 are in a format that can be readily understood and acted upon by the AI models, such as JSON for structured data queries or plain text for language generation tasks.

The task templates 109 may include prompt templates with system prompts, instructions, special tokens, or variables that can be used for common generative AI tasks such as summarization, question answering, data extraction, chat, sentiment analysis, text classification, etc. In certain implementations, the client application 128 may also define a particular task template that may be programmed into the API application 102 or stored in the datastore 130 for re-use over time.

The safety filter 112 and privacy controller 110 may include a set of computer-executable instructions to scrutinize and ensure the appropriateness of outputs from model application 114. It functions by applying a set of rules to identify and omit any content that fails to meet specific safety standards. This includes, but is not limited to, the exclusion of personally identifiable information (PII), protection of intellectual property, and the prevention of prompt injection vulnerabilities which could compromise client systems or datastores such as datastore 130.

The model application 114 may include a set of computer-executable instructions that enable it to serve as the execution environment for various AI models. It acts as a host for the AI models, receiving structured prompts from the prompt manager 108, which are then processed by the appropriate AI models to generate outputs. When client application 128 identifies specific models to be used, model application 114 provides the necessary computational resources and environment for these models to function efficiently. The model application 114 module can handle multiple AI models concurrently, allowing for responses to be generated in parallel. It supports a scalable architecture that can accommodate an increasing number of models as dictated by the volume and complexity of the incoming prompts from client application 128. Further, model application 114 can ensure that the generated outputs conform to the expected data types and structures as specified by the API application 102. It integrates with components such as the type checker 118 and the structure controller 120 to verify that the outputs are accurate and to format them accordingly before they are relayed back to the API application 102.

The controlled decoder 116 module may include a set of computer-executable instructions that enable it to enforce specific types or structures on outputs generated by the model applications 114. When the client application 128 stipulates in its request that the API application 102 could ensure outputs conform to certain data structures (like integers, floats, JSON, XML, categorical data, etc.), the API application 102 may embed these control instructions in its subsequent requests to the model applications 114. The model applications 114, drawing upon these directives, may deploy the controlled decoder 116 to shape the output from generative AI models to fit these structure specifications. The controlled decoder 116 may utilize predefined or user-defined regex patterns, context-free grammars, or other pattern recognitions to dictate the permissible output tokens from the AI models.

Also not explicitly pictured, the model application 114 may include one or more modules or model implementations that allow the execution of models that is end-to-end encrypted. Specifically, these modules may allow the prompts sent from the client application 128 to be encrytped in the client application 128 and allow the models in the model application 114 to process the prompts without decrypting them. In this way, the data sent from the client application can be sent to the server device 100 without comprising the privacy of the data. In certain implementations, the model application 114 may integrate full hormomorphic encryption into one or more layers of the model that the model application 114 hosts (e.g., Llama 3 or Mistral).

The type checker 118 module may include computer-executable instructions for verifying the data type integrity of outputs generated by the LLM models. For example, the type checker 118 could assess outputs from the model applications 114 to ensure they align with the data type (e.g., integer, string, Boolean) expected by the API application 102 based on the initial request. If the API application 102 specifies that the result should be of a particular data type, the type checker 118 casts the AI-generated output into the appropriate type before it is sent back to the API application 102. This verification could be performed either before the model applications 114 relay their outputs, to ensure conformity to expected data types, or after the outputs have been returned to the API application 102 for a final check before processing. Additionally, the type checker 118 may interface with the prompt manager 108 to ensure that the prompts sent to the model applications 114 solicit responses in the correct data format, further mitigating the risk of hallucinatory or erroneous outputs.

The structure controller 120 module may include a set of computer-executable instructions for ensuring that outputs from generative AI models adhere to a specified format as dictated by the API application 102. For example, if the API application 102 requires a particular output structure, it may provide a corresponding schema to the model applications 114. This schema could be in various formats such as XML, RAIL, JSON Schemas, or handlebars, for instance. Upon receipt of this schema, the structure controller 120 within the model applications 114 is tasked with imposing the defined structure on the AI-generated outputs. To effectively enforce the prescribed format, the structure controller 120 may undertake several actions: (i) it may repeatedly invoke LLMs or other generative models, utilizing control flow statements and efficiently leveraging previously generated values and cache to iterate towards the requested output format; (ii) it may embed specific instructions within the text prompts originating from the API application 102, which in turn are passed from the client application 128, directing the generative AI models to produce outputs that conform to the stipulated structure; (iii) it may autonomously initiate inference retries if the AI model outputs partially or wholly fail to match the desired structure; (iv) it may switch between different generative AI models—for example, from Llama 2 to WizardCoder or from Nous Hermes to MPT—if a model is unable to consistently generate the required fields or structures as per the specifications; and/or (v) it may rephrase or produce dynamically generated prompts to reengage an LLM in an attempt to elicit a satisfactory output structure.

The model optimizer 122 module may include a set of computer-executable instructions for enhancing the performance and efficiency of data models generated and deployed. The model optimizer 122 module engages in the life cycle management of data model training, fine-tuning, and deployment across computing resources. The model optimizer 122 scrutinizes each model against established performance criteria, such as computational efficiency (e.g., FLOPs), accuracy (e.g., F1 score), and response time (e.g., latency). The model optimizer 122 ensures that the models adhere to predetermined optimization standards, such as reduced parameter count, efficient data type usage, and hyperparameter tuning. For example, if the client application 128 specifies particular performance optimization requirements-such as reduced memory consumption or increased inference speed—the API application 102 enlists the model optimizer 122 to tailor the data models accordingly within the model applications 114. The model optimizer 122 may, for example, parse a graphical depiction of a neural network into a set of hyperparameter tuning instructions for the model. If, despite optimization efforts, model optimizer 122 identifies that the data models do not satisfy the specified performance thresholds, it may invoke a series of corrective actions, potentially including retraining or structural adjustments.

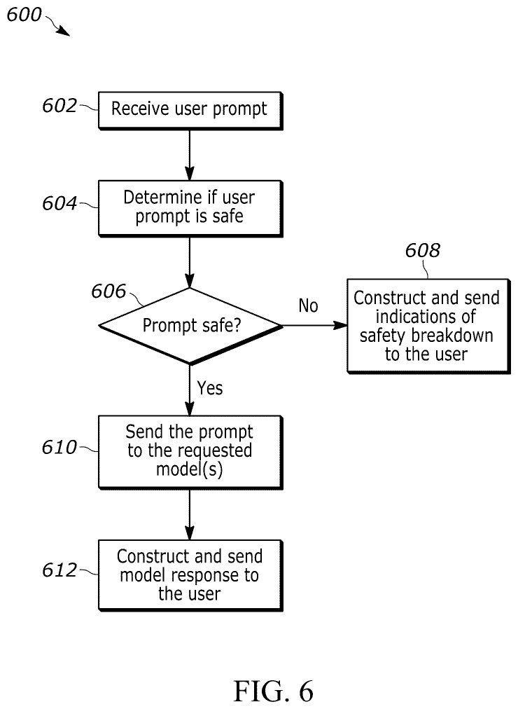

The accelerator(s) 124 are software and/or hardware element(s) specifically tailored/designed as hardware acceleration for AI/ML applications and/or AI/ML tasks. The accelerators 124 used by the model applications 114 to run the generative AI models and decode their output via the controlled decoder 116 may each include one or more specialized processors (e.g., a GPU, Intel Gaudi2 or Gaudi3, Xeon CPU, Intel Data Center Max GPUs, Cerbras, TPU, FPGA, etc.). In certain cases, the model applications 114 may utilize model optimizers to optimize the generative AI models (available via the model applications 114) to either (i) run on commodity hardware; or (ii) run with improved performance on accelerated hardware. In particular, as discussed with greater detail with respect to FIG. 5 below, the model optimizers may optimize a particular generative AI model to run with improved performance on a particular specialized processor (or particular specialized processors) based on input from a user indicating a particular specialized processor (or particular specialized processors) upon which the generative AI model will be run in practice. For example, based on input from a first user of a first generative AI model, indicating that the first generative AI model is to be run on a Gaudi3 processor, the model optimizers may optimize the first generative AI model to run with improved performance on the Gaudi3 processor, and based on input from a second user of a second generative AI model, indicating that the second generative AI model is to be run on a Xeon CPU, the model optimizers may optimize the second generative AI model to run with improve performance on the Xeon CPU. For example, the model optimizer 122 may utilize quantization, re-training, finetuning, distillation, or other relevant techniques such as those implemented in Optimum, OpenVINO, and IPEX to optimize the controlled and validated execution of models on Intel CPUs and GPUs, such as the Intel Data Center Max GPUs or 4th Generation Intel Xeon CPUs. These optimizations may increase performance and efficiency while also allowing the models to be executed in a safe, controlled, and validated manner across multiple GPUs or multiple CPUs (i.e., distributed).

In operation, a user may access the server device 100 (e.g., via a remote client device 126, via the API application 102, etc.). The user may be, for example, a human user of a chat system, a fully autonomous client such as a script, etc. The user may provide an input (e.g., a query) to the server device 100 via the network to the API application 102.

The generative AI models which are run on the accelerator(s) 124 and accessed via a controlled decoder 116 in the model applications 114 could, for example, include any generative LLMs such as those in the following transformer-based model families: LLaMA 3, LLAMA 2, LLAMA, LLaVA, Mistral, Yi, MPT, Falcon, Nous-Hermes, Camel, Pythia, Dolly, RedPajama, Cerebras, OPT, WizardLM, and StarCoder. However, the generative AI models running on the accelerators 124 and accessed via the model applications 114 could include non-transformer-based models, such as RWKV, and multi-modal models such as CLIP. The generative AI models which are run on the accelerators 124 and accessed via a controlled decoder 116 in the model applications 114 could, for example, include any generative LLMs such as those in the following transformer-based model families: LLAMA 2, LLAMA, MPT, Falcon, Nous-Hermes, Camel, Pythia, Dolly, RedPajama, Cerebras, OPT, WizardLM, and StarCoder. However, the generative AI models running on the accelerators 124 and accessed via the model applications 114 could include non-transformer-based models, such as RWKV, and multi-modal models such as CLIP.

The exemplary client application 128 may send one or more text prompts (or prompts composed of a variety of modalities of data) as input to the exemplary API application 102 to receive a controlled and validated response from one or more models, which models are integrated with the API application 102 via their own appropriate API contract or schemas. The API application 102 may execute various pre-inference checks or filters on the text prompts provided by the user. By way of example, these may include checking for Personally Identifying Information (PII), prompt injection vulnerabilities, intellectual property that should be kept private, and other sensitive information (such as snippets of internal company documents). When detecting such private, sensitive, or harmful data in the text prompts, the API application 102 may send the exemplary client application 128 back an error message, error code, or other response warning them that the prompts provided represent a breach in privacy or security. Alternatively or additionally, the API application 102 may automatically select to send the text prompts to one or more privacy-conserving models and not to one or more other models (which might cause a breach of compliance or a company's terms and conditions of service). Finally, the API application 102 may also or alternatively modify (i.e., “sanitize”) the text prompts sent from the exemplary client application 128 to remove, obfuscate, encrypt, substitute, or anonymize certain information in the text prompts prior to sending exposing the text prompts to one or more models.

Assuming the API application 102 determines to send the original or modified (i.e., “sanitized”) versions of the user input to one or more models after the pre-inference checks or filters, the exemplary API application 102 determines if there are control or constraint parameters that should be paired with the user input text prompts when sending the text prompts to one or more models. These control or constraint parameters (or configuration) might be provided by the user or may be determined on-the-fly by the API application 102 (e.g., based on default configurations or predictive detections). In an exemplary scenario, the user may specify either type/structure related controls or output quality related controls.

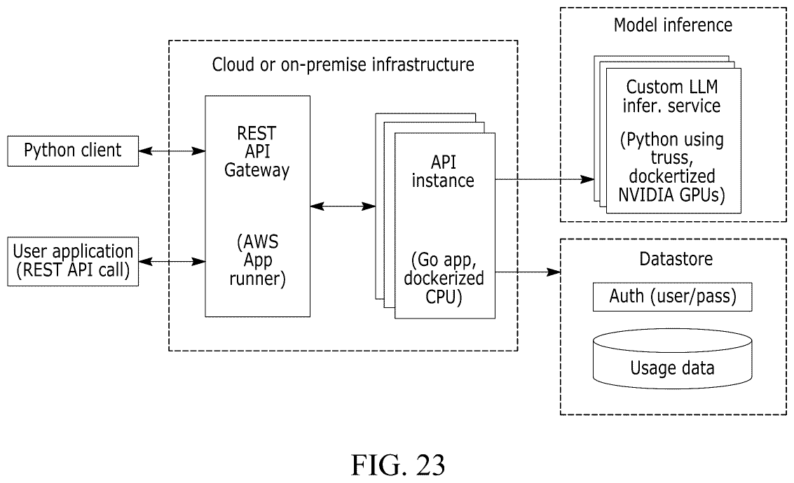

The example type/structure related controls may include: (1) type constraints that define the type (e.g., integer, float, Boolean, or categorical) that should be returned from one or more requested model outputs; and/or (2) structure constraints that define the structure (JSON, XML, CSV, Python code, etc.) that should be returned from the one or more request model outputs. The user-defined type and/or structure constraints may be provided by the exemplary client application 128 to the API application 102 via an API request body, header, URL/URI query string, or configuration file. For example, the user might set a parameter in a request body named “type” that specifies “integer” or “float”. However, the reader will understand that many different formats of configurations and parameter names could be used to specify such constraints. Further examples of such constraints are included in FIGS. 23-35.

Default configurations for constraints may similarly be defined via JSON, database entries, configuration files, or hard coding within the API application 102. These default configurations may be used by the API application 102 dynamically (or on-the-fly) based on a separate call to a predictive model that outputs a probability or other score indicating that the user request is likely to benefit from or the user's intention is that the response be of a certain type. For example, the user may send a text prompt with an instruction that instructs a model with a prefix “determine how many . . . ”. A pre-trained LLM or other predictive model may be used by the API application 102 to determine this user intent and automatically set a type/structure configuration for integer output. Similarly, the API application 102 may determine any number and combination of constraints automatically (e.g., JSON outputs with certain fields and types). The API application 102 may also use rules based or deterministic methods to define or select type and structure constraints.

The example quality related controls may include: (1) a control on the desired factuality or factual consistency of the output returned from one or more models; (2) a control on the desired level or type of toxicity that can be returned from one or more models; (3) a control on the consistency of the output of the one or more models; or (4) a arbitrary control on the output from a second one or more models given inputs from a first one or more models; (5) control on aligning models with a user-provided knowledge base. Like the above-mentioned type/structure constraints, the quality-related controls may be defined by the user (e.g., the client application 128) or may be automatically determined on-the-fly based on the text prompt. For example, the client application 128 may send an API request to the API application 102 with a parameter named “consistency” that is set to TRUE (a Boolean value). Upon receiving this configuration, the API application 102 may concurrently call each request model multiple times, compare the corresponding outputs, and determine if the outputs are consistent with each other either exactly or via some measure such as semantic similarity, edit distance, or Levenshtein distance. If outputs are inconsistent according to a threshold value, then API application 102 may return a response to client application 128 that includes an error message. Alternatively, the API application 102 may return the responses along with a flag or score indicating consistency.

In a similar manner, when receiving indications that the factuality or toxicity of model outputs should be controlled, the API application 102 may send model outputs to supplementary predictive models fine-tuned or trained to predict levels of factuality, factual consistency, or toxicity. These example models may return scores or flags related to factuality or toxicity labels, and the API application 102 may use those to in the construction or filtering of output that is sent back to the client application 128. For example, when toxicity is detected in the output of one or more models, the API application 102 may not return the output from one or more models to the client application 128. It might, instead, return an error message or canned placeholder message. It will be noted that statistical or rules-based methods for detecting factuality or toxicity may be used as an alternative or additional method along with predictive (e.g., neural network) based approaches.

Arbitrary model- or rule-based quality controls may also be user-defined or selected dynamically by the API application 102. These arbitrary controls may include one or more calls to LLMs or other predictive models that are “chained” before or after the call or calls to the one or more models requested by the client application 128. For example, the user might provide both: (i) a first text prompt they should be supplied to one or more LLMs as input; and (ii) and additional LLM text prompt templates that take, as input, the output of the LLM model that is supplied with the first text prompt. In this way, for example, they could have a first prompt that answers a question using an LLM model and then a second prompt that is used to determine (via a second call to an LLM) if the answer (from the first prompt) is humorous. Based on the output of the arbitrary quality controls, the API application 102 may construct a response to the exemplary client application 128 with corresponding error messages, flags, scores, etc.

The type, structure, and quality controls of the API application 102 may advantageously allow the API application 102 to decode only partial outputs from models and automatically re-ask or re-try prompting, which decoding and retries optimizes both the quality of the model outputs and the latency with which a client application 128 obtains a desired level of quality. For example, users of LLMs or other predictive systems often need to iteratively and interactively prompt models to determine proper prompting formats and wording, as many of these models are fragile with respect to small changes in prompt text. Trying to validate model output, without the concurrent and automated control and validation of the systems and methods disclosed here, might require 100's of calls to models. Each of these inference calls may take 5-10 or more seconds, which makes large scale processing (e.g., for data extraction use cases) prohibitively lengthy in processing time. The currently disclosed systems and methods reduce this latency through both concurrency and direct control of models, providing assurance that models will not decode undesired outputs and automatically checking that models are not providing risky outputs. By controlling the outputs of models and reducing the possible space of decoded outputs, the current systems and methods also reduce computational burdens on specialized hardware (e.g., GPUs). By reducing the possible space of output tokens with LLMs, for example, models can respond faster once a structure or type is decoded and matched (compared with more open decoding that could output many unnecessary tokens, increasing loads on expensive GPU hardware).

Some implementations of the API application 102 may be configured with prompt templates, special tokens, and logic that pre-configures LLMs, or other predictive models, for optimized usage related to certain common or relevant tasks. That is, the API application 102 may allow for general text completion in scenarios where the exemplary client applications supplies an arbitrary text completion prompt in the request. However, the API application 102 may also include routes or endpoints that enable certain common predictive tasks such as summarization, rephrasing, question answering, sentiment analysis, factual consistency detection, toxicity detection, chat, machine translation, etc. For example, in addition to integration of model-based factuality check in a general text completion endpoint as described above. For example, the API application 102 may provide a factuality specific endpoint that is pre-configured to the task of factuality detection. In another example, the API application 102 may process chat-specific requests that utilize pre-configured chat prompts, system prompts, and special tokens specific to the chat scenario. These pre-configured prompts may include role-based indicators such as < > and < >, instruction indicators such as [INST], pre-configured instructions such as “Read the context below and answer the provided question”, indications of variables that are substituted on-the-fly such as {question} or {context}, and/or any other common prompt templating and structuring element that are commonly know to those skilled in the art.

In some examples, the API application 102 may be configured to respond to requests from and/or stream information to a client application 128 running on a remote device 126 via a REST or other relevant API protocol. For example, the server device 100 may communicate with the client application 128 over HTTP using JSON request and response bodies. However, anyone of ordinary skill in the art will recognize that the API application 102 and the client application 128 may communicate using any number of API protocols including GRPC, web sockets, etc.

The client application 128 may generate a text prompt, for example, that needs to be supplied to the model applications 114 in a controlled and validated manner. This is done via the exemplary API application 102. The request from the client application 128 may include the identification of one or more models that should specifically be used to generate a response to the text prompt. In that case, a model manager 104 is used to look up the information (e.g., URL or domain) on which the respective one of the model applications 114 is hosted. This model manager may, depending on the number text prompts provided and/or the number of models specified, spin up multiple workers within the API application 102 to currently interact with multiple of the model applications 114, which might be hosting a variety of different models.

In addition to a text prompt the client application 128 may send various optional parameters to the API Application 102 that will be passed through to the model applications 114, and, in their absence, the API application 102 may use default values for the parameters. These parameters may include temperature, top-k, top-p, max tokens, and max new tokens.

If the client application 128 specifies, in a request, that the model applications 114 should be controlled by the API application 102 in a manner to ensure consistency of model outputs, the example consistency sampler 106 may call the specified models, via the model applications 114, multiple times to gather multiple results. In some implementations, the consistency sampler 106 may follow the self-consistency sampling technique in which multiple results are compared to determine a level of consistency from the model applications 114. The various results could be compared via semantic similarity (using embeddings), Levenstein distance, edit distance, or any other appropriate metric. If the results are not deemed consistent based on measures or thresholds of the consistency sampler 106, then the API application 102 may respond to a user with error messages or flags indicating this result. The consistency sampler 106 may also merge or combine the outputs from multiple inferences using statistical or model-based approaches (e.g., another call to an LLM to combine results).

If the client application 128 specifies, in a request, that the model applications 114 should be checked for certain qualities such as factual consistency or toxicity, the API application 102 leverages the quality checker 105 to check the outputs of the model applications 114. The quality checker may, itself, may make additional calls into the model applications 114 so as to retrieve the results from LLMs that are fine-tuned for the tasks of detecting factual consistency, toxicity or other qualities. If the results are not deemed to have certain qualities based on measures or thresholds of the quality checker 105, then the API application 102 may respond to a user with error messages or flags indicating this result.

If the client application 128 specifies, in a request, that the model applications 114 should be called by the API application 102 to produce a certain kind of task specific result, then the API application will use the prompt manager 108 and the task templates 109 when calling the model applications 114.

If the client application 128 specifies, in a request, that the model applications 114 should be directed by the API application 102 to harmonize their outputs with the internal company knowledge base, the example consistency sampler 106 undertakes iterative calls to the model applications 114. Leveraging data extracted from the company's documentation and employing advanced techniques such as Retrieval Augmentation Generation and Recurrent Binary Embedding, the consistency sampler 106 strives to align the model outputs and the company's knowledge base. This alignment, commonly called fine-tuning, is achieved autonomously without human intervention. Should the model outputs fail to align with the internal company knowledge base, by predetermined criteria set by the consistency sampler 106, the API application 102 may promptly issue error messages or raise flags signifying the misalignment.

The API application 102 may determine via a model selector 103 an appropriate task and/or set of models that should be called. For example, the model selector 103 may utilize one of the models available via the model applications 114 to process the request from the client application 128 and determine that the request is requesting a certain task (e.g., summarization). Based on this request intent, the model selector 103 may select a subset of the models available in the model applications 114 that perform best on the detected task, and/or the model selector 103 may communicate with the prompt manager 108 to configure calls to one or more of the models available in the model applications 114.

When requested by the client application 128 or based on certain defaults, the API application 102 may use a privacy controller to filter out personally identifiable information (PII) or other sensitive details in the text prompts sent to the API application 102 from the client application 128. Further the API application 102 may utilize various safety filters 112 to ensure any or multiple of the following: (i) that sensitive information or intellectual property is not included in the text prompts provided by the client application 128; or (ii) that the text prompts sent from the client application 128 do not include prompt injection vulnerabilities (e.g., to gather sensitive information from client systems or datastores such as the datastore 130). The safety filters 112 and the privacy controller 110 may utilize predictive models finetuned or trained to identify PII, sensitive information and prompt injections, or they may use deterministic, statistical, or rules-based approaches. In certain scenarios, the client application 128 may upload examples of sensitive data to the API application 102. The API application 102 may process these and store data profiles or embedding associated with these examples in the datastore 130. The sensitive filters 112 and/or the privacy controller 110 may then utilize these data profiles in comparisons to text prompts. Similarity measures (such as cosine similarity or similar) may be used by the safety filters 112 and/or the privacy controller to filter out vulnerabilities or data breaches.

If the client application 128 specifies, in a request, that the API application 102 should control the outputs from the model applications 114 to conform to certain types or structures (integer, float, JSON, XML, categorical, etc.), the API application 102 may format these controls into the requests that it subsequently sends to the model applications 114. Based on these control specifications, the model applications 114 control the decoding from generative AI models (or other relevant predictive models) to conform to the control specifications. The controlled decoder 116 may accept pre-defined or user-supplied regex patterns, context free grammars, or other patterns or schemes to define acceptable output tokens from the generative AI models.

In certain cases, the controlled decoder 116 may start the generation from a model with an empty prefix (or an empty string). Then it may concatenate or enumerate all tokens of the vocabulary to the prefix. These tokens may be words, characters, or subwords. For every possible next token in the generation, the controlled decoder 116 may use a parser along with the regex or context free grammar pattern to determine which possible output tokens can lead to a result that matches the regex or context free grammar pattern. Tokens that cannot result in an allowed pattern are “masked” by, for example, setting a probability or logit value to 0.0 (or other artificial value). The masked probabilities or logits may then be used by the controlled decoder to generate new tokens until the specified pattern is complete. Rather than matching in a sequential manner as specified above, one of skill in the art will also recognize that a similar controlled decoding could be achieved using finite state machines, such as a Deterministic Finite Automaton (DFA) or other appropriate implementation, and implemented using transitions of that finite state machine.

If a certain type, such as integer or Boolean, was specified in the request from the API application 102 to the model applications 114, the model applications 114 may use a type checker 118 to cast the output from generative AI models into appropriate types prior to returning them to the API application 102. However, such type checking could also occur after the model applications 114 return results to the API application 102.

The API application 102 may also specify a certain format that should be returned based on the output of generative AI models accessed via the model applications 114. The API application 102 may, in these cases, supply a relevant schema to the model applications 114, which schema specifies the desired format. Schemas including or similar to XML, RAIL, JSON Schemas, or handlebars may be provided by way of example. When received, a structure controller 120 of the model applications 114 may enforce this structure on the outputs of the generative AI models. To enforce the structure the structure controller 120 may do one or multiple of the following: (i) call LLMs or other generative models multiple times using some control flow statements optimally reusing values from previous generations and caches to progress through the desired output structure; (ii) inject instructions into text prompts received from the API application 102 (passed on from the client application 128) instructing the generative AI models to output according to the desired structure; (iii) automatically perform inference retires when some or all of the generative AI model output does not conform to the desired and specified structure; (iv) automatically switch generative AI models (e.g., from Llama 2 to WizardCoder or Nous Hermes to MPT) when one model fails to produce certain fields or structures consistent with a specification; and/or (v) rephrase or automatically prompt an LLM in with a dynamically generated prompt or rephrase to try and generate acceptable output.

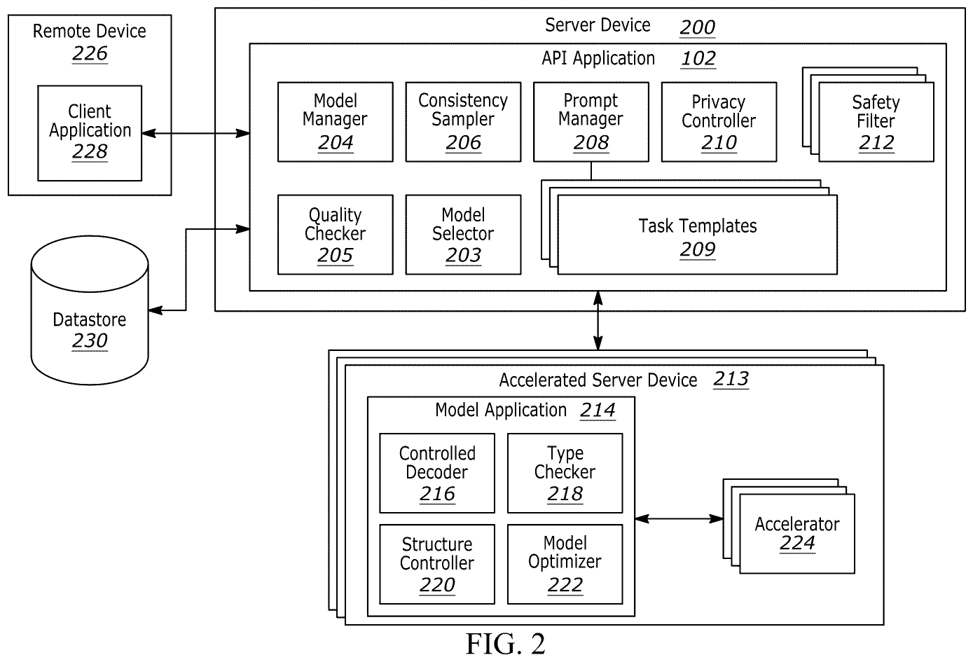

It will be appreciated by anyone of ordinary skill in the art that the modules 104, 106, 108, 110, 112, 105, 103, 109, 116, 118, 120, and 122 may be integrated across one or both of the API application 102 and the model applications 114 in a variety of combinations. Further, as illustrated in FIG. 2, similar modules 204, 206, 208, 210, 212, 205, 203, 209, 216, 218, 220, and 222 may be spread across multiple virtual or physical services located in the same or different physical locations and/or the same or different networks.

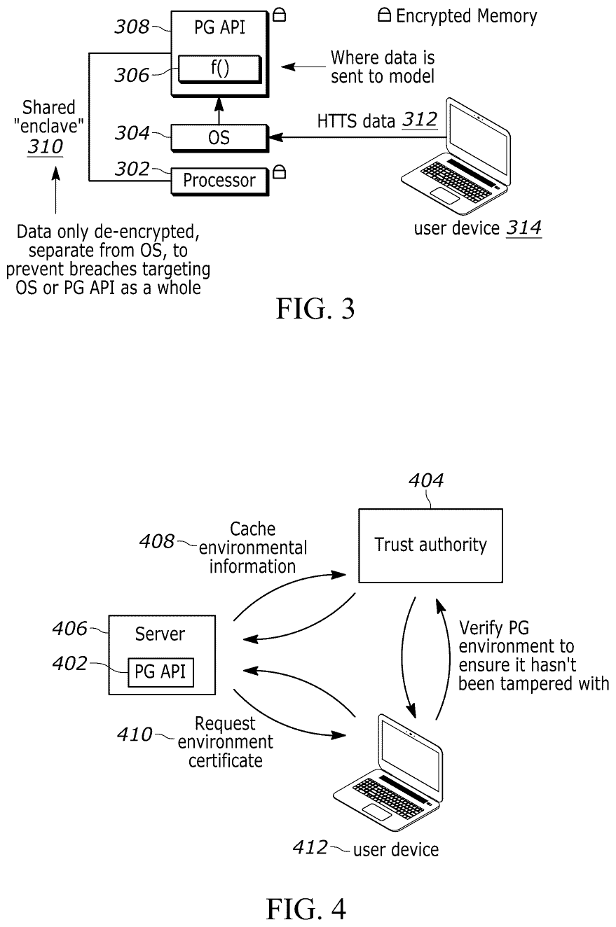

FIG. 3 presents a secure processing architecture of managing user data within a trusted execution environment (TEE) on a server, incorporating encrypted memory and carefully controlled data decryption protocols. As shown in FIG. 3, a lock symbol is used to indicate areas where data is encrypted. Data within these areas is secure and protected from unauthorized access, ensuring that sensitive information remains protected at all stages of processing within the architecture. This architecture may be designed to prevent unauthorized access to sensitive information throughout the data's lifecycle, ensuring that decrypted data is processed only within a “secure enclave” (the TEE) and never exposed outside this environment. Accordingly, even if another user (i.e., a bad actor) gains access to the server or the API, the other user cannot access the secure enclave of the TEE.

The system architecture of FIG. 3 includes a processor 302, an operating system 304, a model (or a particular function within a model) 306 and a prediction-guard application programming interface (API) 308. The processors 302 and the model (or particular function within the model) 306 may operate within the TEE 310 and may be responsible for executing specific tasks required by the prediction-guard application API 308. The prediction-guard API 308 may facilitate the interaction between the model (or particular function within the model) 306 and external entities by securely transmitting data that has been processed within the TEE 310. The TEE 310, shared by the processor 302 and the model (or particular function within the model) 306, may protect the decrypted data from any potential breaches targeting the operating system 304 or the prediction-guard API 308 as a whole.

User data, including HTTS data 312, is sensitive and thus may be encrypted before being transmitted to the server. This encryption may be maintained throughout the memory managed by the operating system 304, ensuring that the data remains protected during transmission and storage. Upon reaching the server, the encrypted data may be managed by the prediction-guard API 308 and may be routed to the model (or particular function within the model) 306 within the TEE 310. In some embodiments, decryption of the data may solely occur within the secure enclave TEE 310, ensuring that the decrypted is never exposed outside this protected environment.

FIG. 3 further illustrates the flow of data between the user device 320 and the operating system 304. Once the encrypted data arrives at the server, the encrypted data may be handled by the prediction-guard API 308, which directs the encrypted data to the model (or particular function within the model) 306 within the TEE 310. Decryption may solely occur within the TEE 310, after which the data can be used for inference or other processing tasks required by the application, such as inference tasks. The data may be re-encrypted before leaving the TEE 310, ensuring continuous protection.

The TEE 310 is an isolated environment (e.g., an “enclave”) that may be specifically designed to securely handle decrypted data, in a manner preventing unauthorized access. The architecture shown at FIG. 3 incorporates “encryption split technology,” which ensures that data is decrypted only within the TEE 310, separate from the operating system 304. In this example, this separation may protect the data from potential breaches targeting the operating system 304 or the prediction-guard API 308, as decrypted data is never processed or stored outside the TEE 310.

The architecture may also help mitigate decrypted HTTS data 312, or any other sensitive information, from being written to persistent storage or cache. All decrypted data processing may occur entirely within the TEE 310. This approach may help minimize the risk of unauthorized access to decrypted data, even by internal personnel, by restricting the decryption process to the TEE 310.

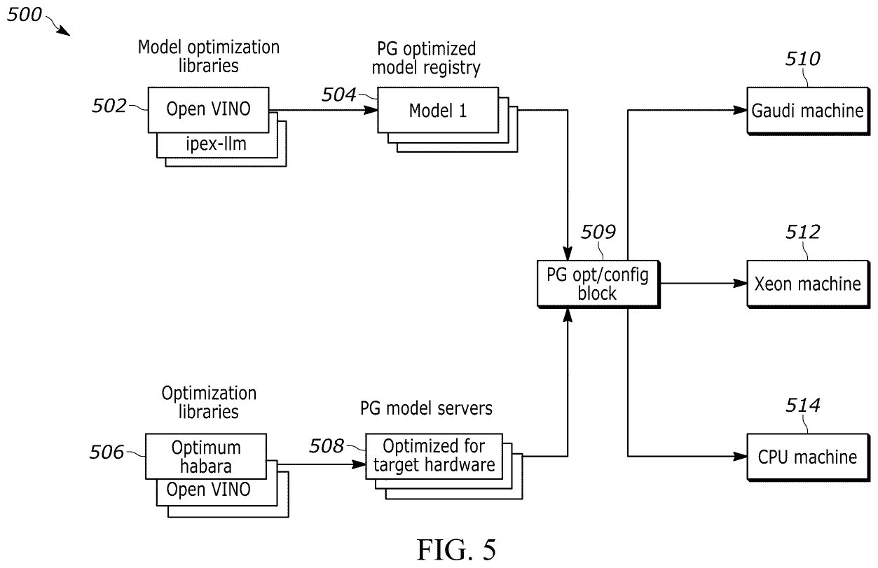

FIG. 4 illustrates a system architecture that may be used to deploy and maintain the integrity of the prediction-guard application API 402 (e.g., corresponding to the prediction-guard application API 308 discussed above with respect to FIG. 3) within a secure server environment. The architecture is designed to ensure that interactions involving the prediction-guard application API 402 are conducted securely, with mechanisms in place for the collection of environmental data and external verification by a Trust Authority 404. This setup is intended to safeguard the prediction-guard application API 402's operational environment against tampering and unauthorized modifications. In some embodiments, the server 406 hosting the prediction-guard application API 402 may include a dedicated module for collecting environmental information 408. This module may gather data about the server's current operational state, which could include details such as hardware specifications (e.g., processor type, memory configurations), software versions (e.g., operating system, middleware, application software), and configuration settings (e.g., security policies, network parameters, firewall settings). The collected data may provide a snapshot of the server's environment at a specific time and could be compiled into an environment certificate 410. This environment certificate 410 may serve as a formalized record of the server's operational environment, capturing all relevant details that could be necessary for subsequent verification. The environment certificate 410 may then be transmitted to an external Trust Authority 404, which could be, for example, an Intel® Trust Authority. The Trust Authority 404 may be responsible for validating that the environment where the prediction-guard application API 402 is deployed adheres to required security standards and has not been compromised. The verification process conducted by the Trust Authority 404 may include several critical checks, such as assessing hardware integrity to ensure that no unauthorized hardware modifications have been made, verifying software authenticity to confirm that all software components are genuine and unaltered, and ensuring that the server's security policies are correctly configured and enforced. After the verification process is complete, the Trust Authority 404 may send a response back to the server 406, providing a validation status that indicates whether the environment is considered secure. If the verification is successful, the prediction-guard application API 402 may continue to operate within this validated environment, with the assurance that the environment has not been tampered with and meets the necessary security requirements. If any issues or discrepancies are identified during the verification process, the server 406 may be prompted to take corrective actions, such as reconfiguring security settings or updating software components, to address potential vulnerabilities and restore the environment's integrity.

FIG. 5 is block diagram depicting a system 500 that may be used for optimizing and deploying LLMs across various hardware platforms, such that the models may be tailored to the unique characteristics of each processor type and may deliver improved performance during execution. LLMs that are created and trained using various frameworks may then be passed to a model optimization block 502, where techniques such as quantization, pruning, and architecture modification may be applied to enhance particular LLMs for specific hardware platforms. In some embodiments, the system may utilize model optimization libraries (e.g., OpenVINO, TensorFlow Lite) to align the hardware with the selected LLM capabilities, based on their compatibility. In certain embodiments, optimized models may be stored in an optimized model registry 504, categorized by their hardware compatibility.

The system 500 may further include code optimization libraries 506 (e.g., Optimum Habana, OpenVINO) and model servers 508 to enhance the LLM's performance based on the specific processor characteristics. This enhancement may involve parameter adjustment, hyperparameter tuning, or computational graph restructuring to fully leverage the hardware's capabilities. Furthermore, the system 500 may manage the optimized LLM by registering it, along with other pre-optimized models, in the optimized model registry 504. The system may ensure that the LLMs are executed efficiently by leveraging both model optimization libraries 502 and code optimization libraries 504 to fine-tune the hardware settings and apply performance-enhancing adjustments

The models may then be distributed (block 509) to appropriate hardware platforms, including GPUs, CPUs, and specialized accelerators. As shown in FIG. 5, for instance, the models may be distributed to a Gaudi machine 510, a Xeon machine 512, and/or a CPU machine 514. In various examples, the models may be distributed to any number of different hardware platforms. In some examples, once the models are distributed to the various hardware platforms 510, 512, 514, the performance of the models on the various hardware platforms may be monitored. For instance, metrics such as latency and throughput may be collected, providing valuable data on the models' real-world performance on the respective hardware. In some examples, this data may be fed back into the model optimization block 502, enabling iterative improvements based on performance, with ongoing refinement driven by continuous performance monitoring.

### Example Methods

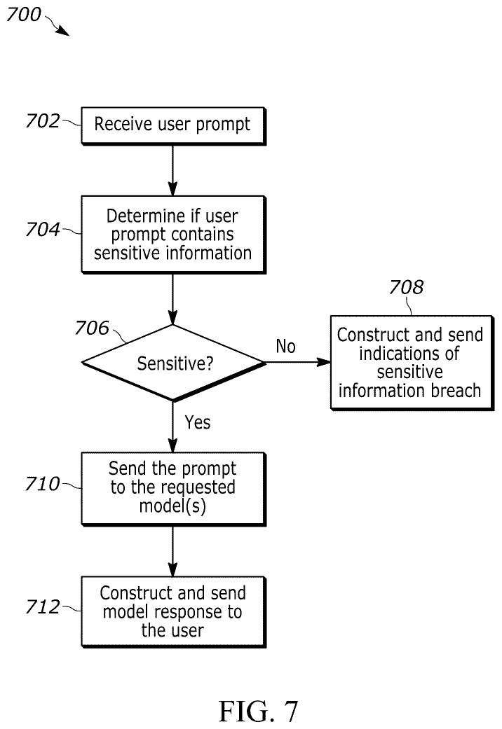

FIGS. 6-13 and 15-18 describe various methods that may be implemented by combinations of hardware, software, firmware, etc., for example, by components of FIGS. 1-5, such as the exemplary server device 100, the exemplary server device 200, the accelerated server devices 213, etc.

FIG. 6 is a method diagram depicting exemplary method 600 for the system's process of evaluating and handling user input for safety, according to an aspect. Method 600 encompasses various steps beginning with step 602, where the system receives a user prompt. At step 604, the system determines the safety of the user prompt. If found unsafe at decision step 606, the system constructs and sends an indication of the safety breakdown to the user at step 608. Conversely, if the prompt is deemed safe, it is then sent to the requested model(s) at step 610. Finally, at step 612, the system constructs and sends the model's response back to the user. The API application 102 serves as the entry point for receiving the user prompt. The safety filter 112 assesses the safety of the prompt. The prompt manager 108 may be involved in managing the flow of prompts based on their safety assessment and in constructing indications of safety breakdowns. The model manager 104 may direct the safe prompts to the appropriate model(s) and may involve the model selector 103 to choose the best-suited model for the given prompt. The model application 114, which may the controlled decoder 116, would generate the appropriate responses to the prompts. Finally, the task templates 109 could provide structural templates for constructing the responses sent to the user.

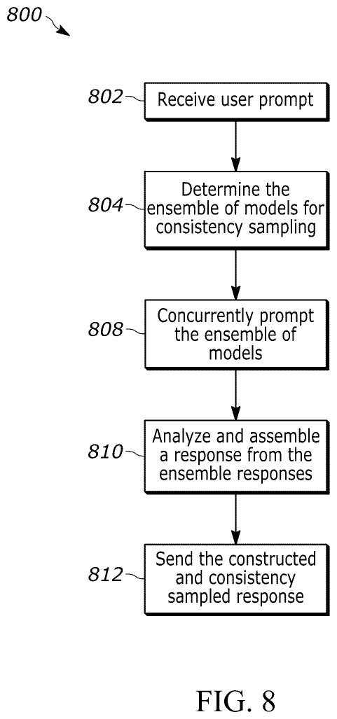

FIG. 7 is a method diagram of exemplary method 700 for the system's process of evaluating and handling user input for sensitive information, according to an aspect. This method commences at step 702 with the system receiving a user prompt. At step 704, the system assesses whether the prompt contains sensitive information. If the prompt is determined to be sensitive at decision step 706, the system then constructs and communicates indications of sensitive information breach at step 708. If the prompt is not sensitive, it is forwarded to the requested model(s) at step 710. The process culminates at step 712 with the system constructing and sending the model's response to the user. The API application 102 serves as the entry point for receiving the user prompt. The privacy controller 110 assesses the sensitivity of the prompt, playing a critical role in step 704. If the prompt is sensitive, the privacy controller may construct indications of sensitive information breaches to the user. The prompt manager manages the flow of the prompts and the construction of the response if the prompt is not sensitive. The model manager 104 may direct the non-sensitive prompts to the appropriate model(s), potentially using the model selector 103 to determine the best model for the prompt. The model application 114, which includes the controlled decoder 116 would generate the response to the user's prompt.

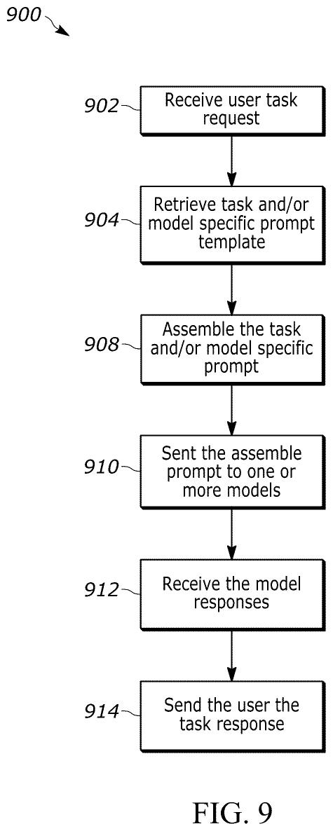

FIG. 8 is a method diagram of exemplary method 800 for the system's consistency sampler, which iteratively invokes designated models via model applications, employing methods like self-consistency sampling and amalgamating outputs from multiple inferences through statistical or model-based approaches, yielding final output, according to an aspect; The process begins at step 802, where a user prompt is received by the system. At step 804, the system may determine a set of models to form an ensemble for consistency sampling. Then, at step 808, the system may concurrently prompts this ensemble of models. After receiving the various responses, step 510 involves analyzing and assembling these into a singular, consistent response. Finally, the constructed response that has been consistency sampled may be sent to the user at step 512. In the context of the system architecture from FIG. 1, this method may involve the model manager 104 to determine the ensemble of models suitable for the prompt. The consistency sampler 106 could then be used to manage the concurrent prompting and to gather the responses for consistency. The model application 114 may include the actual ensemble of models providing individual responses. The quality checker 105 could be involved in analyzing the responses for consistency, and the task templates 109 may offer structural frameworks for response assembly. Once a consistent response is formulated, the prompt manager 108 could handle the communication of the response back to the user.

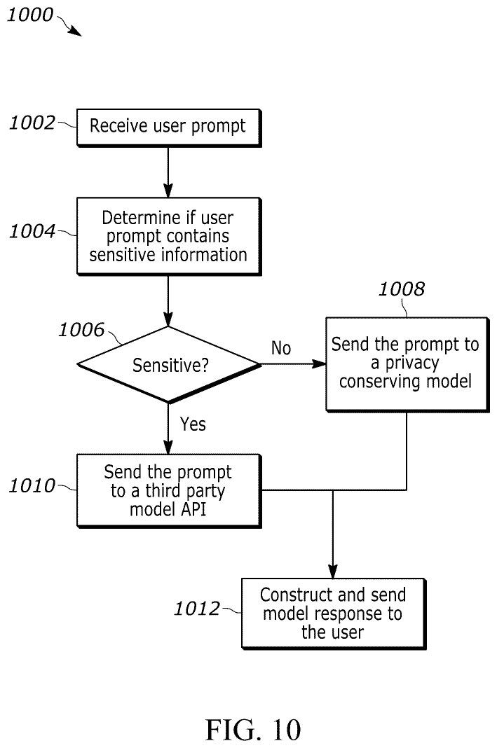

FIG. 9 is a method diagram of method 900 of an exemplary system's process of receiving of a user's task request, followed by retrieval and compilation of a model/task-specific prompt, which then may used by one or more models, with the receiving model responding by delivering the task response to the user, according to an aspect. The method begins at step 902, where the system receives a user task request. At step 904, the system may retrieve a task and/or model-specific prompt template. Moving on to step 908, the system may assemble the task and/or model-specific prompt. Then, at step 610, the assembled prompt could be sent to one or more models. The system could then receive the model responses at step 612. Finally, at step 614, the system may send the user the task response. In the context of the system architecture from FIG. 1, this method may deploy the task templates 109 module for retrieving the appropriate prompt templates related to the user's task request. The model manager 104 could be implicated in assembling the prompt based on the task and model requirements. The model selector 103 could be used to determine the specific models to which the prompt should be sent, especially if multiple models can handle different aspects of the task. The model application 114 could include the various models that may receive the prompt and generate the responses. Finally, the prompt manager 108 could oversee sending the assembled and model-generated responses to the user.

In some examples, to further enhance the privacy and relevance of the generated responses, the method 600 may additionally incorporate differential privacy techniques during the prompt assembly and response generation process to create synthetically private examples from sensitive data, allowing for the improvement of model performance without compromising privacy. These differential privacy techniques may involve pre-processing data on the client side to generate differentially private examples that can be included in prompts for models, ensuring that private information included in examples provided in user prompts cannot be recovered.

For example, if real examples of a particular type of social media post were included in a prompt, those real examples could be pre-processed to generate synthetic examples of the particular type of social media post that do not include any real users, real usernames, etc., and those synthetic examples can be provided as the prompt to the model, i.e., rather than the real examples. As another examples, if real examples of a type of healthcare writeup were included in a prompt, those examples could be pre-processed to generate synthetic examples of the particular type of healthcare writeup that do not include any real patients, real diagnoses, etc., and those synthetic examples can be provided as the prompt to the model, i.e., rather than the real examples.

For instance, at step 604, when retrieving a task and/or model-specific prompt template, the system may ensure that any user-specific data involved is processed through a differential privacy-based anonymization mechanism. This process may convert private data into synthesized, non-sensitive data that is then incorporated into the prompt templates. Moreover, in some examples, during step 608, the system may assemble the task and/or model-specific prompt by integrating the anonymized, synthesized data, ensuring that sensitive information is protected. Additionally, in some examples, at step 610, when sending the assembled prompt to one or more models, the system may utilize a method that guarantees sensitive information remains encrypted and secure throughout the process. Furthermore, in some examples, at step 612, upon receiving the model responses, the system may employ predefined criteria to evaluate the alignment of the outputs with the internal company knowledge base and user-specific templates. If the outputs fail to meet these criteria, error messages or flags may be issued to indicate misalignment, i.e., to ensure that responses are consistent with the company's internal knowledge and customized to meet individual user expectations. Finally, at step 614, the system may send the task response to the user, maintaining the integrity and privacy of the data throughout the entire process.

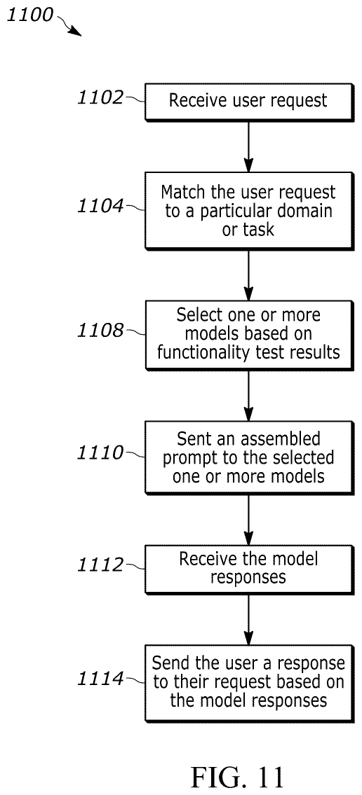

FIG. 10 is a method diagram of method 1000 of an exemplary system's process of categorizing user prompts for privacy, directing non-sensitive ones to a privacy-focused model and sensitive ones to a third-party API, to provide corresponding responses, according to an aspect. The method initiates at step 1002, where the system receives a user prompt. At step 1004, it determines whether the prompt includes sensitive information. If the prompt is identified as sensitive at decision step 1006, it is sent to a third-party model API at step 1010. Conversely, if the prompt is not sensitive, it is sent to a privacy-conserving model at step 1008. The process concludes with step 1012, where the system constructs and sends the model response to the user. In the context of the system architecture from FIG. 1, this method may deploy the privacy controller 110 for assessing the sensitivity of the prompt, and the model manager 104, which would route the prompt to the appropriate model based on its sensitivity. The model selector 103 may assist in this routing by selecting either the third-party model API or the privacy-conserving model. The prompt manager 108 could oversee the final construction of the response to the user, ensuring that the response is appropriate and maintains the user's privacy.

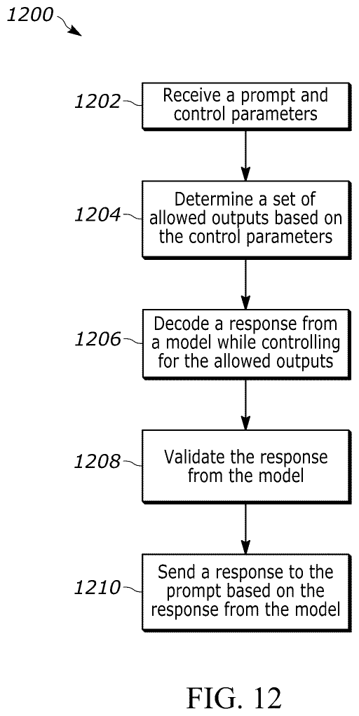

FIG. 11 is a method diagram of method of 1100 an exemplary model's process of handling user requests, domain/task identification, model selection through functionality tests, prompt transmission, model response reception, and user response generation, according to an aspect. The method starts at step 1102 with the reception of a user request. At step 1104, the system matches the user request to a specific domain or task. Moving forward, at step 1108, one or more models are selected based on functionality test results. An assembled prompt is then sent to the chosen models at step 1110. The system receives the models' responses at step 1112. Finally, at step 1114, the system sends a response to the user based on the model responses. In the context of the system architecture from FIG. 1, method 1100 may deploy the task templates 109 module to match the user request with the appropriate domain or task template. The model selector 103 module could be used to choose the models based on their functionality test results. The model manager 104 could facilitate the assembly and dispatch of prompts to the selected models. The model application 114, incorporating the various models, could generate the responses to the prompts. Lastly, the prompt manager 108 could compile the model responses and sending the final response back to the user.

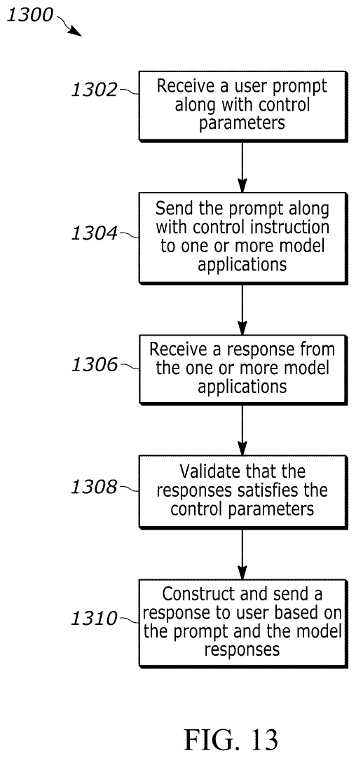

FIG. 12 is a block diagram of method 1200 an exemplary sequence of prompt reception, control parameter application, response decoding within constraints, validation, and reply generation based on the model's output, according to an aspect. The method initiates at step 1202, where the system receives a user prompt along with control parameters. At step 1204, a set of allowed outputs is determined based on these control parameters. The system then decodes a response from a model while controlling for the allowed outputs at step 1206. Following this, the response from the model is validated at step 1208. The method concludes with step 910, where the system sends a response to the prompt based on the model's validated response. This process ensures that the generated responses are in line with predefined constraints, enhancing the relevance and appropriateness of the content provided to the user. In the context of the system architecture from FIG. 1, prompt manager 108 could handle the initial reception of the prompt and the control parameters, while the model application 114, could generate the response within the specified output parameters. The quality checker 105 may validate the response to ensure it meets the system's quality standards before the final response is communicated to the user by the prompt manager 108.

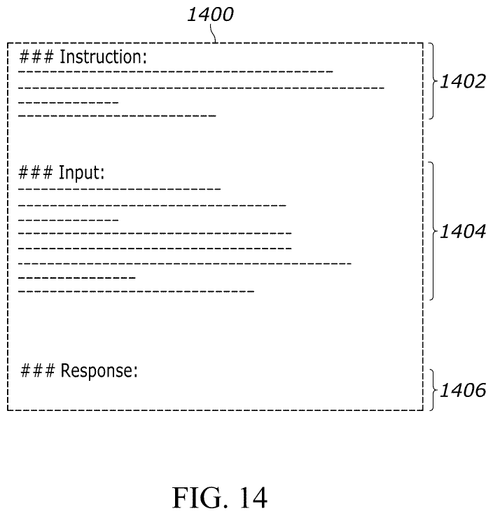

FIG. 13 is a block diagram of method 1300 of receiving user prompt and control parameters, which are forwarded to one or more model applications with control instructions, followed by receiving a model response, validating that response against the control parameters, and finally constructing and sending a user response based on the prompt and model responses, according to an aspect. The method initiates at step 1302, where the system may receive a prompt accompanied by control parameters. The prompt and control instructions may then send to one or more model applications 114 at step 1304. Subsequently, at step 1306, a response may be received from these model applications 114. At step 1308, the system may validate that the response satisfies the control parameters. The process is completed at step 1310, where a response may be constructed and sent to the user based on the initial prompt and the responses from the model applications. In the context of the system architecture from FIG. 1, the prompt manager 108 may manage the reception of the prompt and control parameters. The model manager 104 could oversee sending the prompt to the model applications and may deploy the model selector 103 to choose the appropriate models for the task. The model application 114 could include the models that generate the responses, which are then validated, by the quality checker 105 module, to ensure they align with the control parameters. Finally, the prompt manager 108 may send the validated and constructed response back to the user.

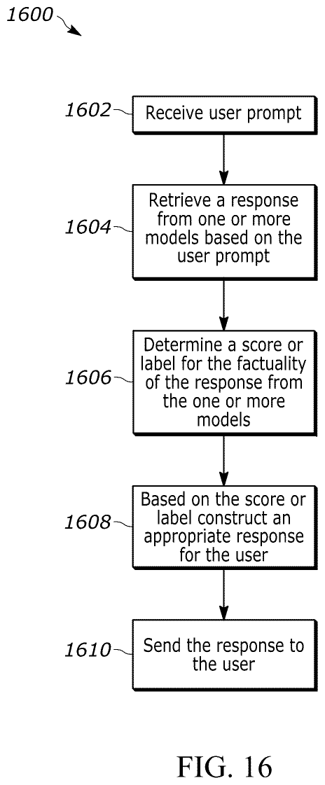

FIG. 15 is a method diagram of method 1500 of an exemplary safeguarding mechanism for an automated system that generates responses to user prompts, ensuring that sensitive information is detected and handled appropriately before any response is generated, according to an aspect. The process starts at step 1502, where the system receives a user prompt. At step 1504, a data profile for the user prompt is created. This profile is then compared to the profile of reference sensitive data at step 1506. If the prompt is deemed sensitive at decision step 1508, the system constructs and sends indications of sensitive information detection to the user at step 1510. Conversely, if the prompt is not sensitive, it is sent to the requested model(s) at step 1512. The method concludes with step 1514, where the system constructs and sends the model response to the user. In the context of the system architecture from FIG. 1, the Privacy Controller 110 may the prompt's sensitivity. The model manager 104 could handle the sending of non-sensitive prompts to the appropriate models, by using the model selector 103. The model application 114 and controlled decoder 116 would be responsible for generating the responses. If sensitive information is detected, the prompt manager 108 would manage the communication to the user regarding the detection of sensitive information, with the controlled decoder 116 generating the response.

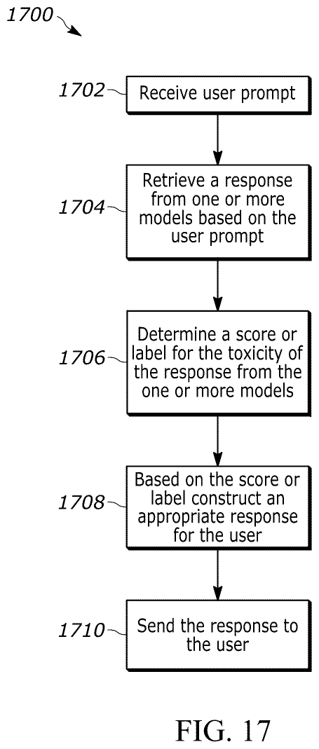

FIG. 16 is a block diagram of method 1600, which depicts an exemplary sequence for evaluating and managing a user prompt. This sequence focuses on delivering a response that has been scored for its factual accuracy, according to one aspect of the disclosed methods. The process starts at step 1602, where the system receives a user prompt. At step 1604, a response is retrieved from one or more models based on the user prompt. The system then determines a score or label for the factual accuracy of the response from the one or more models at step 1606. Based on the score or label, an appropriate response for the user is constructed at step 1608. The process concludes with step 1610, where the constructed response is sent to the user. In the context of the system architecture from FIG. 1, the model application 114 may generate initial responses to the user's prompt. The quality checker could score and/or label the responses for factual accuracy. The task templates 109 might be utilized to structure the response appropriately. Finally, the prompt manager 108 could manage the delivery of the verified and constructed response to the user.

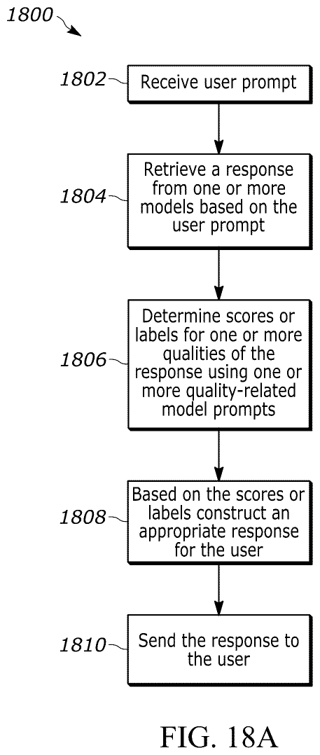

FIG. 17 is a block diagram of method 1700, depicting an exemplary procedure for processing a user prompt with an emphasis on ensuring content safety. The process starts at step 1702, where the system receives a user prompt. At step 1704, it retrieves a response from one or more models tailored to the user prompt. Next, at step 1706, the response undergoes evaluation for toxicity, and a score or label is assigned to gauge its appropriateness. Based on the results of this assessment, an appropriate response is constructed at step 1708. Finally, this response is communicated to the user at step 1710. In the context of the system architecture from FIG. 1, the safety Controller 112 may assess the toxicity of the responses, ensuring compliance with content safety standards. The model manager 104 and model selector 103 may select the appropriate models to retrieve responses. Once the responses are scored for toxicity, the quality checker 105 may verify that the responses meet the system's safety criteria. Finally, the prompt manager 108 could manage the delivery of the verified and constructed response to the user.

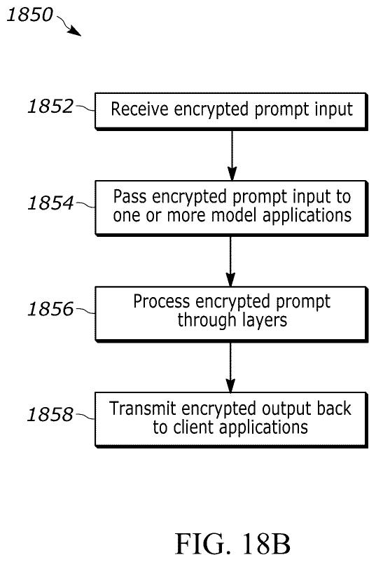

FIG. 18A is a block diagram of method 1800, depicting an exemplary sequence for processing a user prompt by assessing various quality metrics within a computational system. The method begins at step 1802 with the system receiving a user prompt. At step 1804, a response is retrieved from one or more models based on the prompt. The system then determines scores or labels for one or more qualities of the response using quality-related model prompts at step 1806. Based on these evaluations, an appropriate response for the user is constructed at step 1808. The method concludes with step 1510, where the response is sent to the user. In the context of the system architecture from FIG. 1, the model manager 104 may coordinate the retrieval of responses from the models, the model selector 103 may aid selecting the appropriate model(s) that will generate the response, and the quality checker 105 for determining the scores or labels that assess the response's quality aspects. Finally, the prompt manager 108 may construct and dispatch the refined response to the user.

FIG. 18B is a block diagram of the method 1850, depicting an exemplary sequence for end-to-end encrypted execution of AI models. The method begins at step 1552 where a system (e.g., the server device 100) receives an encrypted prompt input from a client application (e.g., the client application 128). The encryption may be completed on the client application using one or more secrets, keys, or certificates. At step 1554, the system passes the encrypted prompt input to one or more model applications that provide the encrypted prompt to be processed by one or more models (e.g., Llama 3 or Mistral). At step 1556, the one or more model applications process the encrypted prompt through the layers of one or more models or LLMs (e.g., Llama 3 or Mistral) to produce encrypted output. The one or more models are, in certain implementations, pre-trained and not specifically modified in any way (e.g., by fine-tuning or otherwise adjusting the serialized weights, biases, or other parameters) to process encrypted inputs. Rather, the one or more model applications may wrap or adjust the runtime execution of the pre-trained models inserting functionality to process the encrypted prompts into useful outputs (without decrypting). This wrapping or adjustment allows the model servers to utilize pre-trained models/LLMs that normally operate on unencrypted inputs, but use them in an end-to-end encrypted manner. In certain implementations, this adjustment of the execution of the pre-trained models is optimized for the hardware on which the model applications are running (e.g., CPU, Gaudi 2 or Gaudi 3) to improve the latency, memory usage or other aspects of the execution. The optimization may include quantization of model or encryption parameters, exchanging of processor operations for other processor operations, pruning layers of execution or operations, etc. Finally, at step 1558, the one or more model applications sends the encrypted output back to the client applications where it can be decrypted.

### Additional Examples

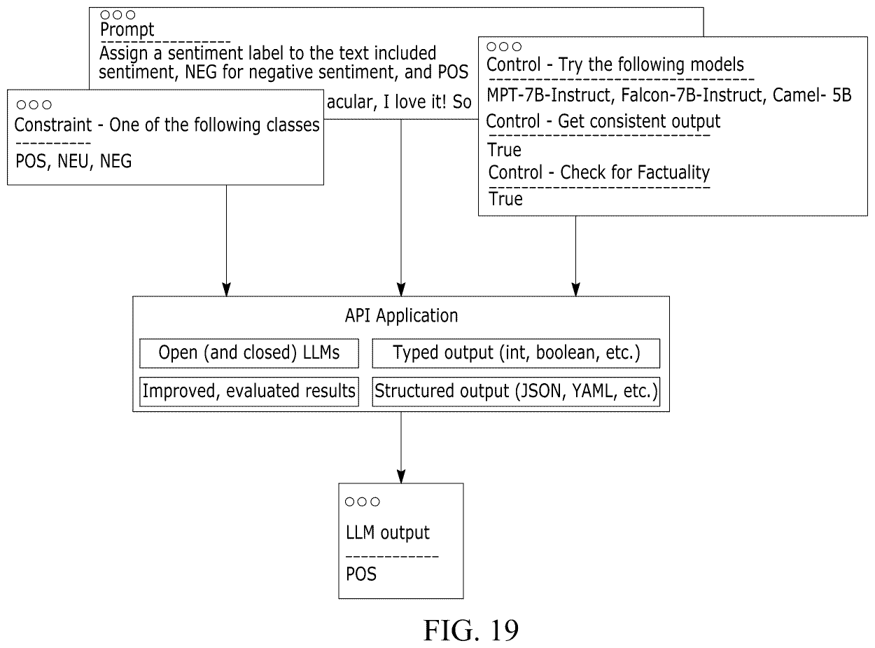

FIG. 19 is an exemplary command line interface setup where an API Application (Green Block; 1901) mediates between varied LLMs and a Terminal Prompt (Black Terminal/Console Background; 1902a), with Controls (1902b) for model selection and accuracy, Constraints (Black Terminal/Console Background; 1902c) for input-output sorting, and an LLM Output (1902d) indicating sentiment classification, according to an aspect.

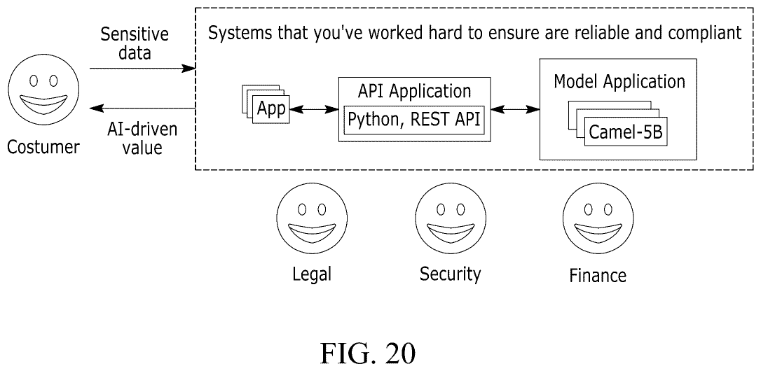

FIG. 20 is a block flow diagram of a user-centric AI workflow diagram where sensitive data is processed through a Python and REST API-driven system, interfacing with models to ensure outputs are reliable and compliant with legal, security, and financial standards, indicated by positive emojis, in an open structure, according to an aspect.

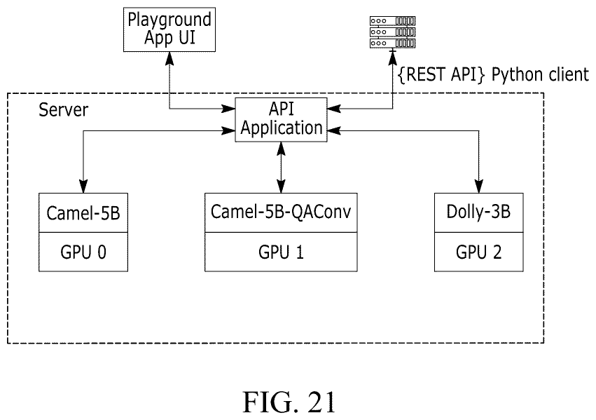

FIG. 21 is a block flow diagram of an exemplary system architecture diagram for a CLI-based environment utilizing various language models to process data under constraints and produce structured outputs, comprising a command Playground, a visual output App UI, REST API and Python client for interaction, a central processing Server, dedicated language model Applications, and several GPUs for optimized processing, all configured for flexible and scalable operations such as text generation and language translation, according to an aspect.

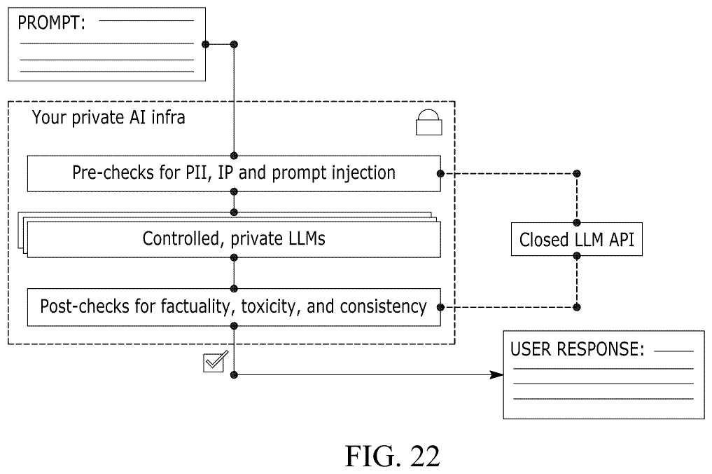

FIG. 22 is a high-level overview schematic of an exemplary processing infrastructure, outlining the sequence from initial user prompt input through various security and quality checks, resulting in user response output, according to an aspect.

FIG. 23 is a block flow diagram of an exemplary general infrastructure for API-driven interactions, where a client application requests services from a cloud or on-premise system, which process the data through a model inference system and accesses a datastore for authentication and usage tracking, according to an aspect.

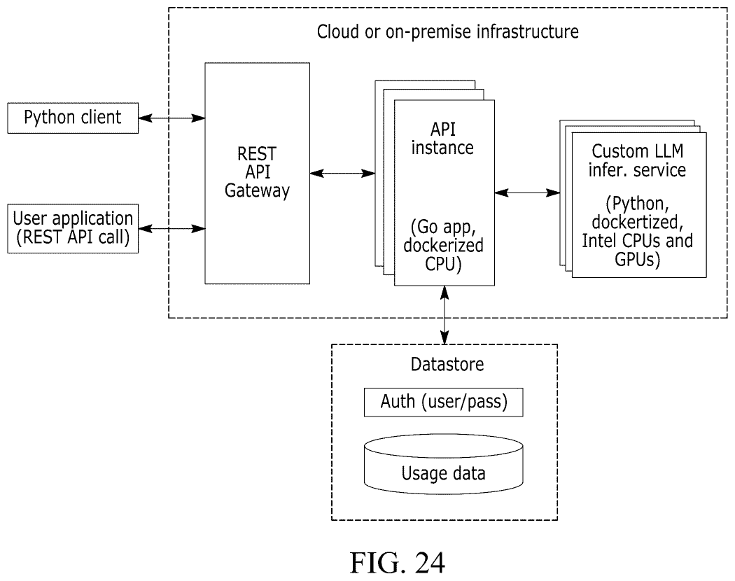

FIG. 24, presents an alternative implementation of FIG. 20, according to an aspect.

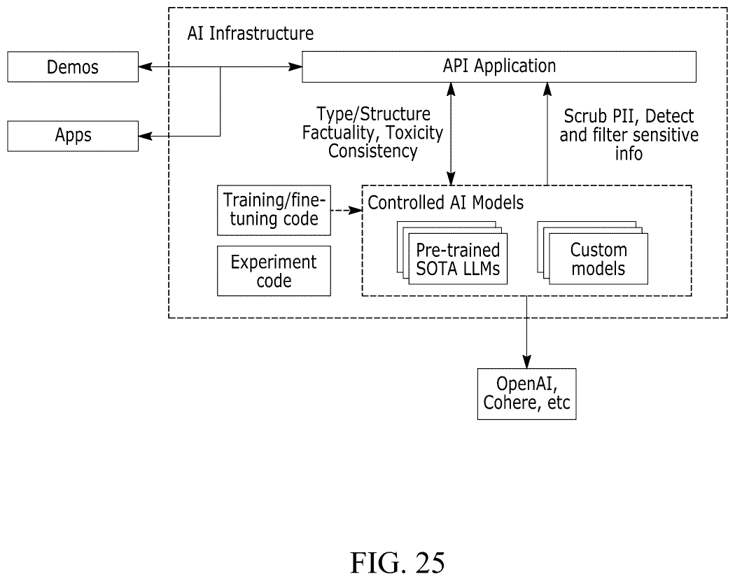

FIG. 25 is an AI Infrastructure framework, of an exemplary AI application's infrastructure with interactive demos, API interfacing, integration of custom LLMs, and capabilities for model training, experimentation, data management, and consistent output generation, according to an aspect.

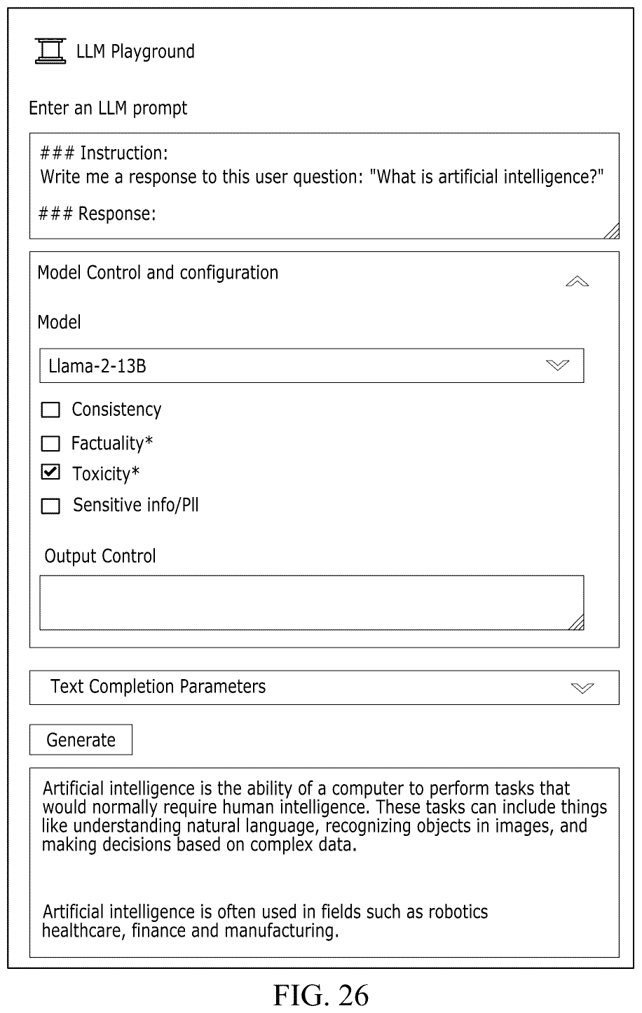

FIG. 26 is an exemplary graphical user interface for input/output, with enabled model selection, and activated toxicity safeguard, according to an aspect.

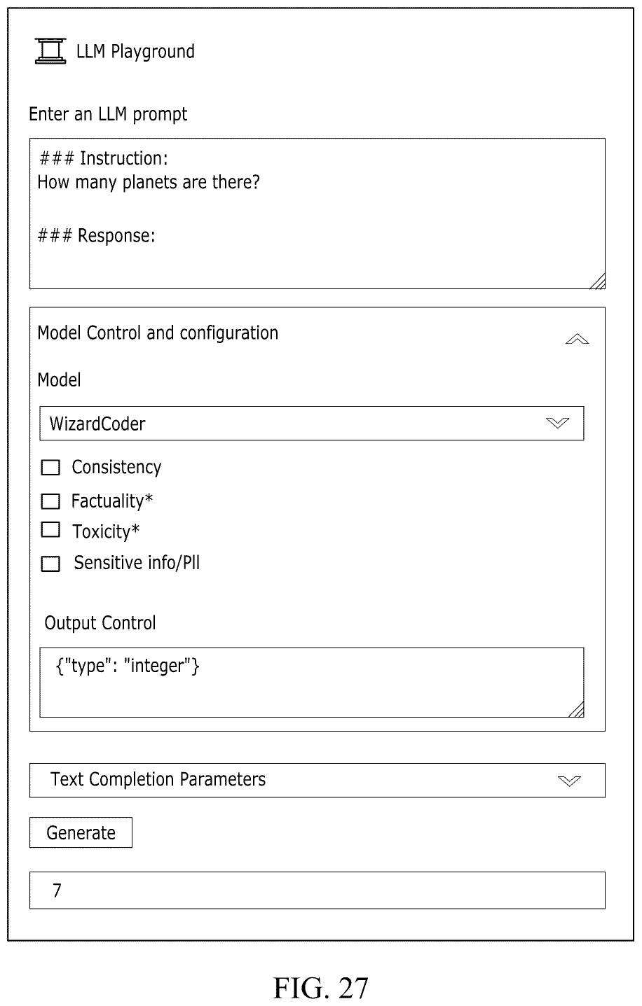

FIG. 27 is an alternative visualization of the graphical user interface shown in FIG. 26, including enabling of “type constraints”, specifically datatype integer, to constrain model output generation, according to an aspect.

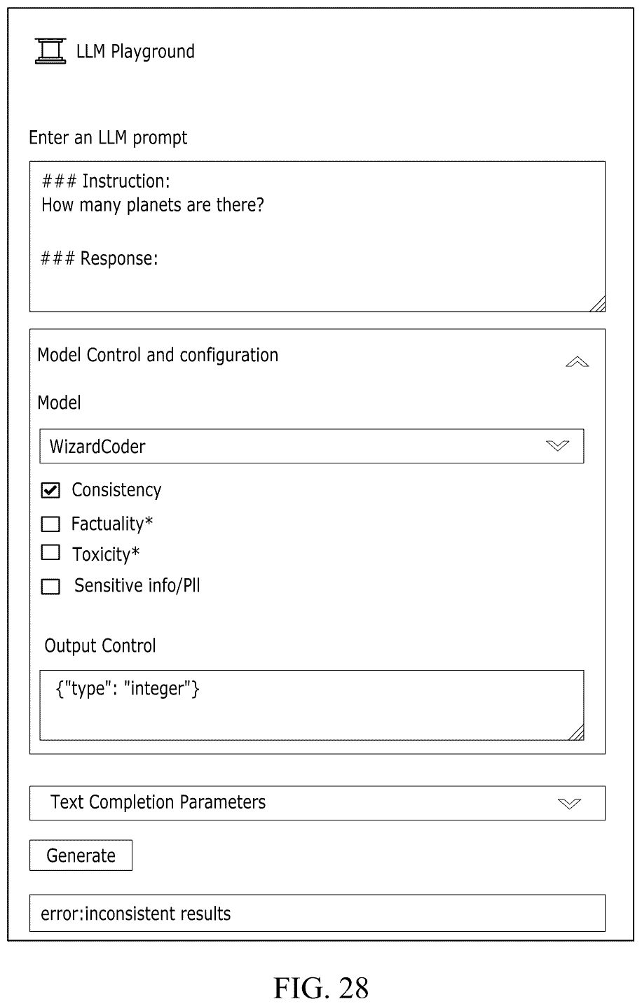

FIG. 28 is an alternative visualization of the graphical user interface shown in FIG. 27, now demonstrating activation of the consistency safeguard, according to an aspect.

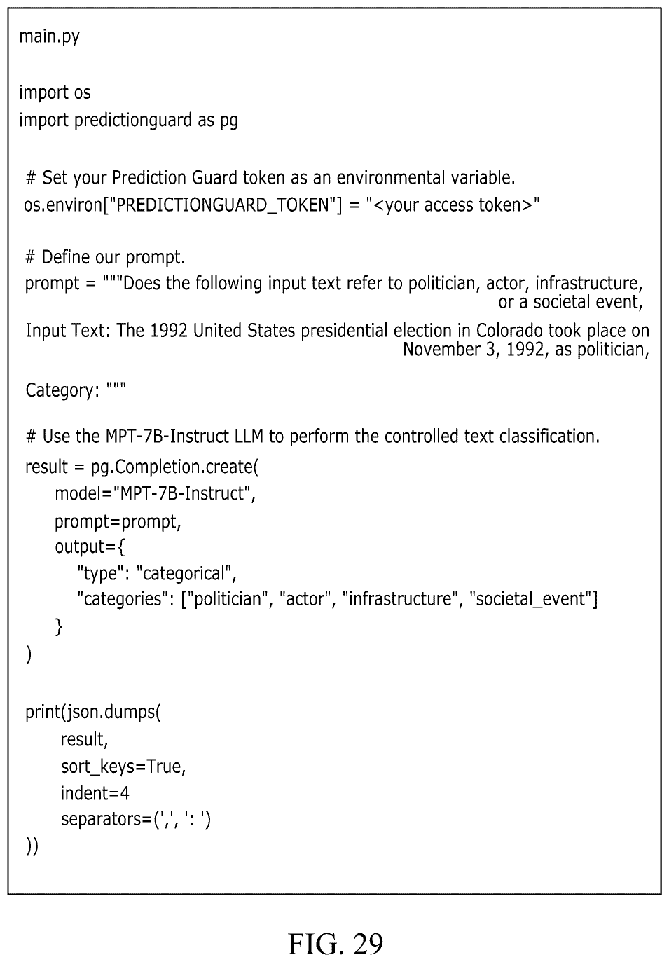

FIG. 29 is a Python code example using the “prediction guard” library to categorize text prompts, configuring environmental variables for authentication, defining the input prompt, invoking a text classification model, and outputting the results in a readable JSON format with sorted keys and indented structure, according to an aspect.

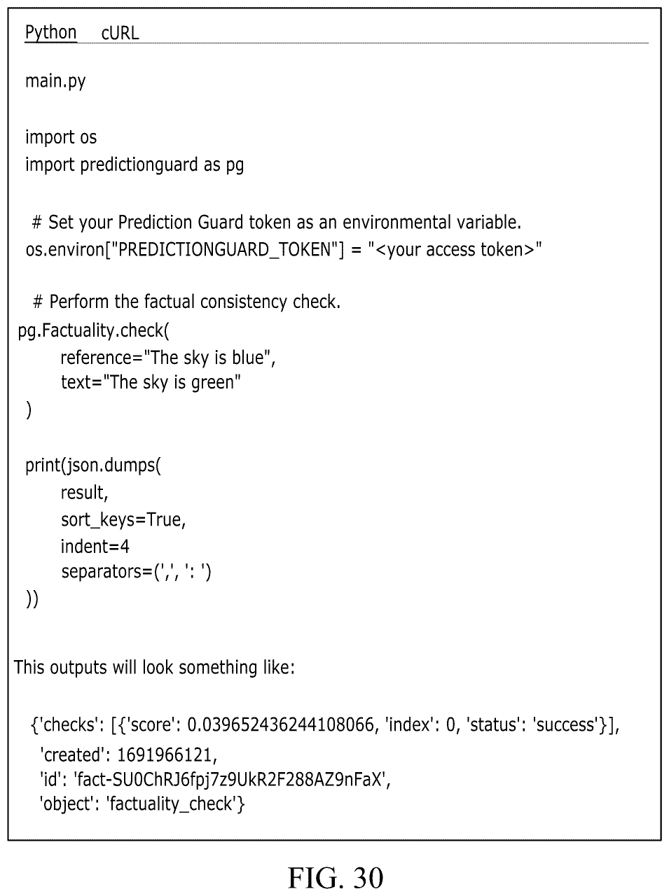

FIG. 30 is a Python code example demonstrating use of the “factual consistency check” function within the prediction guard library, with the necessary bindings, which evaluates the factuality of user inputs, and returns verification results, according to an aspect.

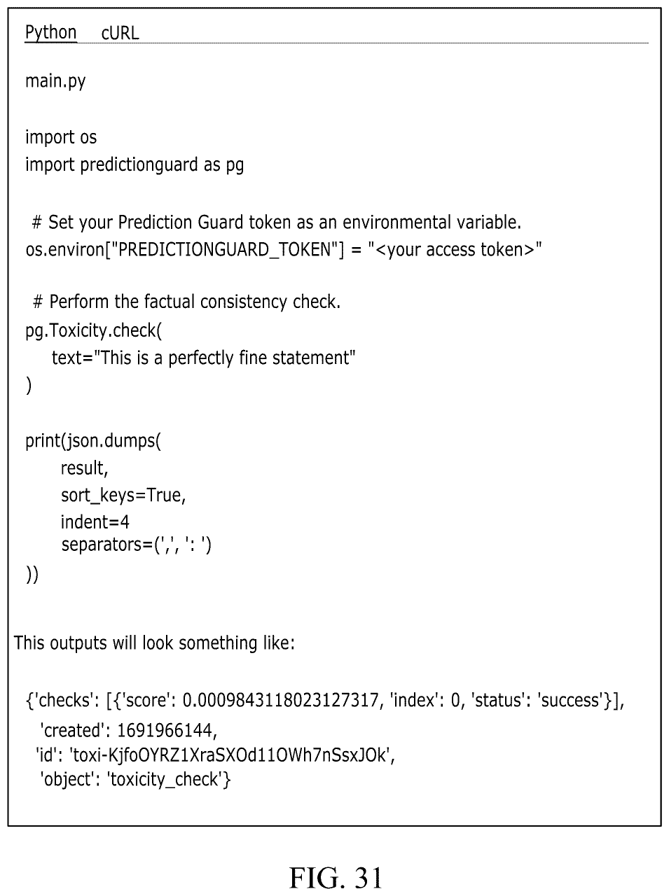

FIG. 31 is a Python code example demonstrating use of the “toxicity check” function within the prediction guard library, with the necessary bindings, to evaluate and handle toxic content within user inputs, according to an aspect.

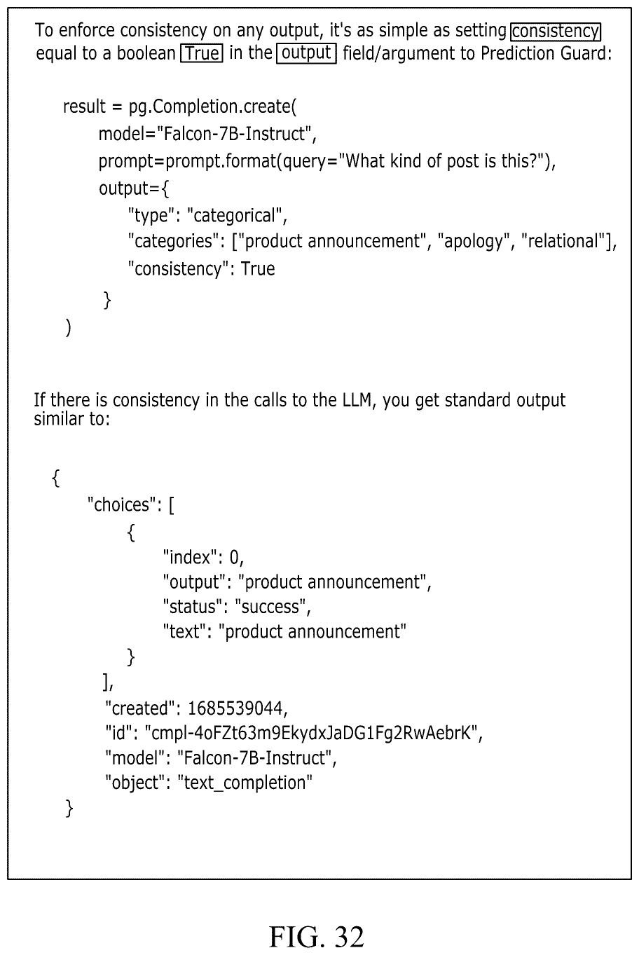

FIG. 32 is a Python code example that ensures LLM output consistency by setting the ‘consistency’ parameter to ‘true’ in the ‘output’ field of the prediction guard function, guaranteeing uniform LLM results, according to an aspect.

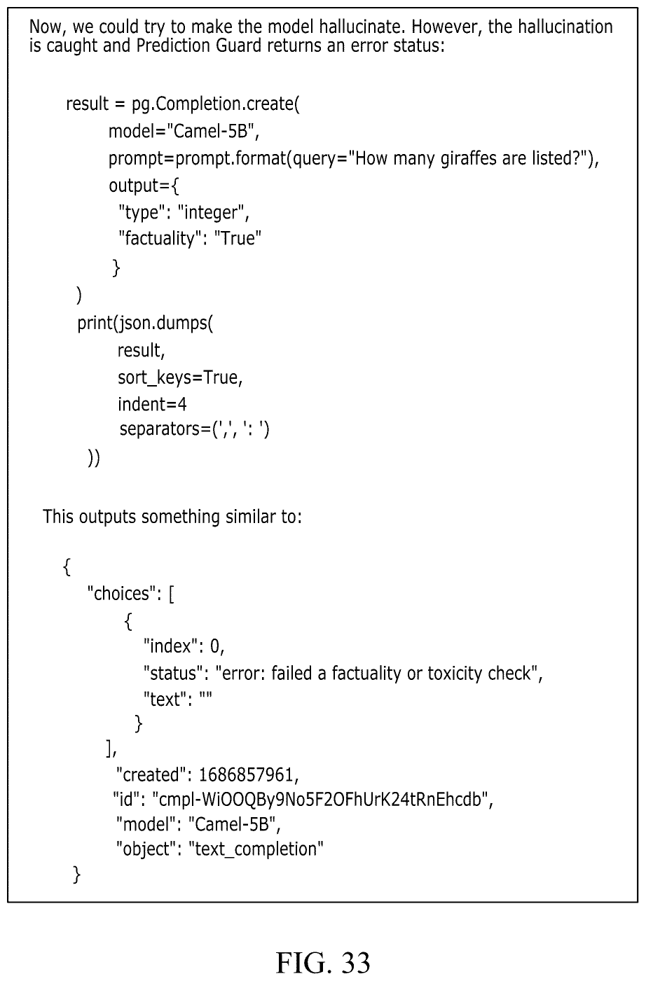

FIG. 33 is a Python code example of a model's ability to detect and intercept hallucinations, upon which it returns error status to user, according to an aspect.

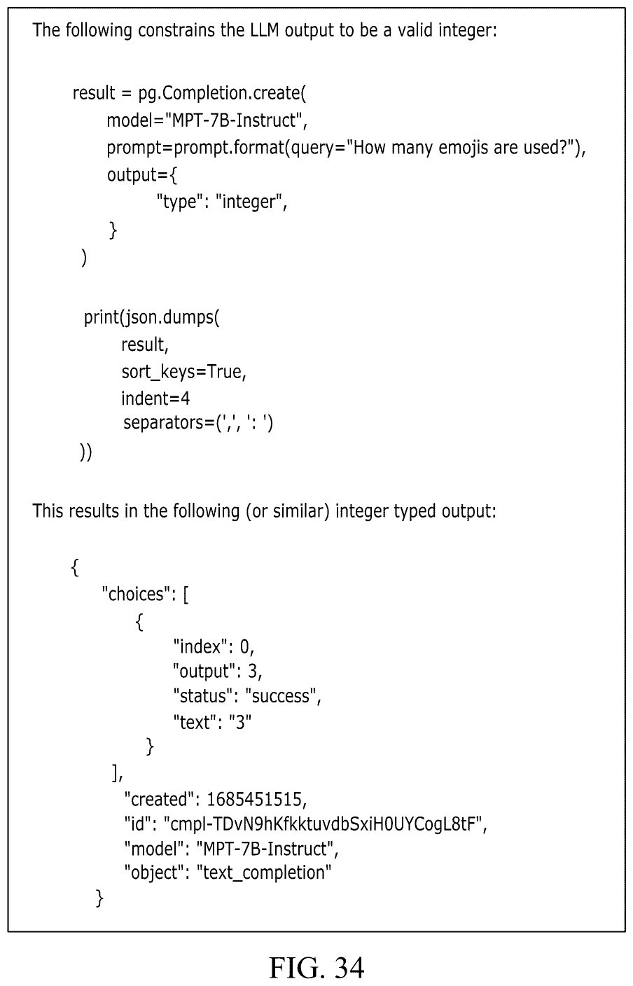

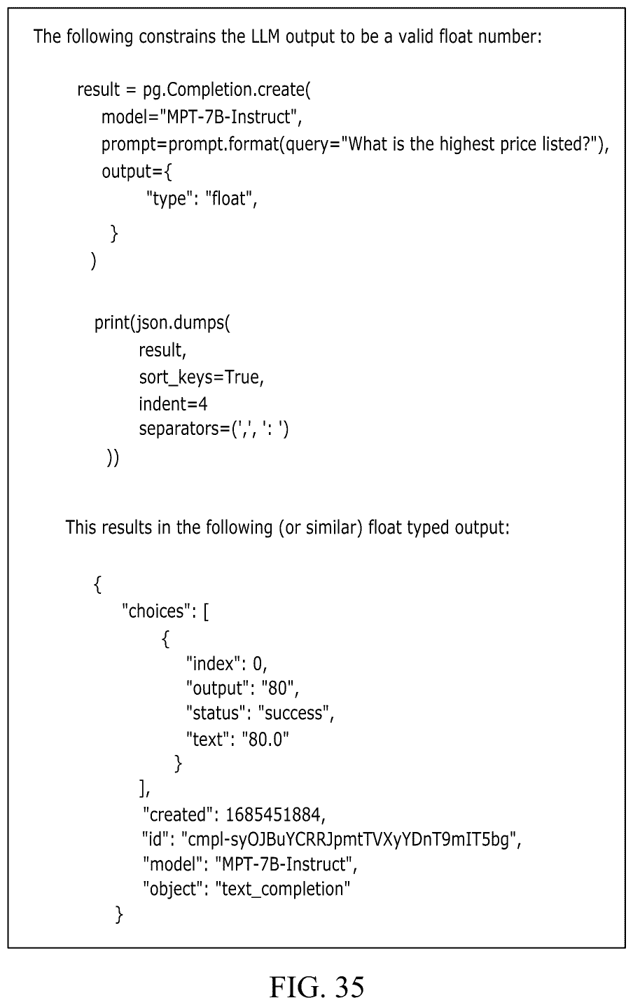

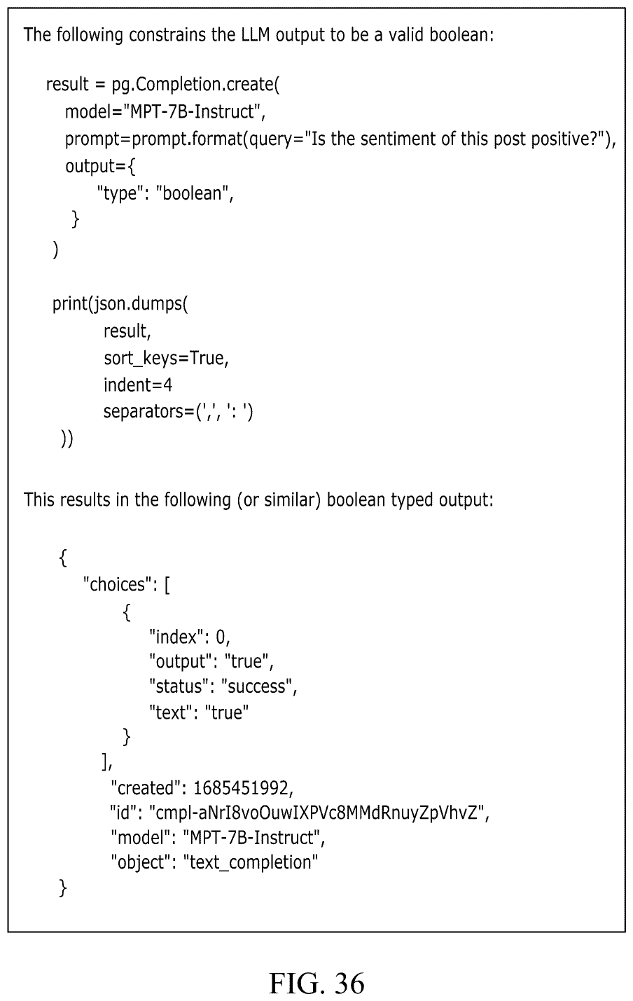

FIGS. 34-36 are Python code examples of a model's ability to ensure LLM outputs conform to specific primitive data types, such as valid integers (FIG. 34), floating-point numbers (FIG. 35), and Booleans (FIG. 36), according to an aspect.

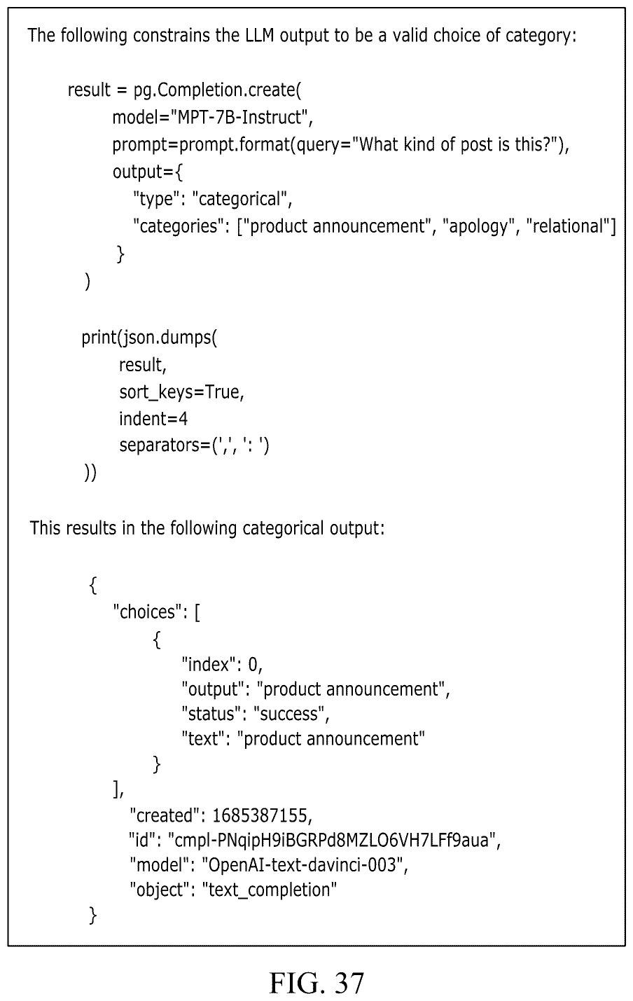

FIG. 37 is a Python code example of a model's ability to constrain LLM outputs to user-specified categorical outputs, according to an aspect.

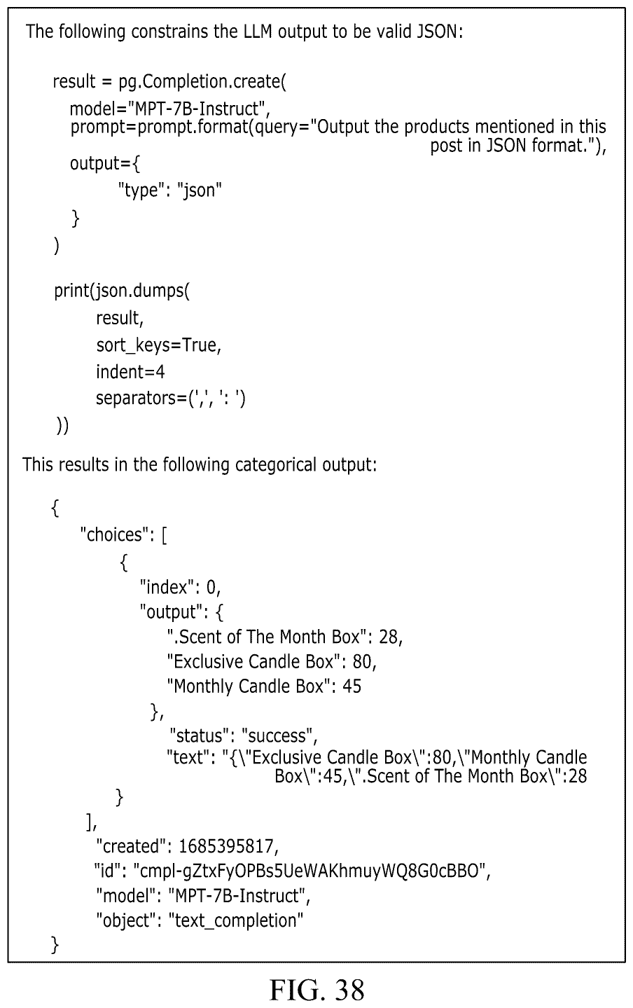

FIG. 38 is a Python code example of a model's capability to constrain LLM outputs to non-primitive datatypes, user-defined data structures, incorporating JSON and object-type constraints, according to an aspect.

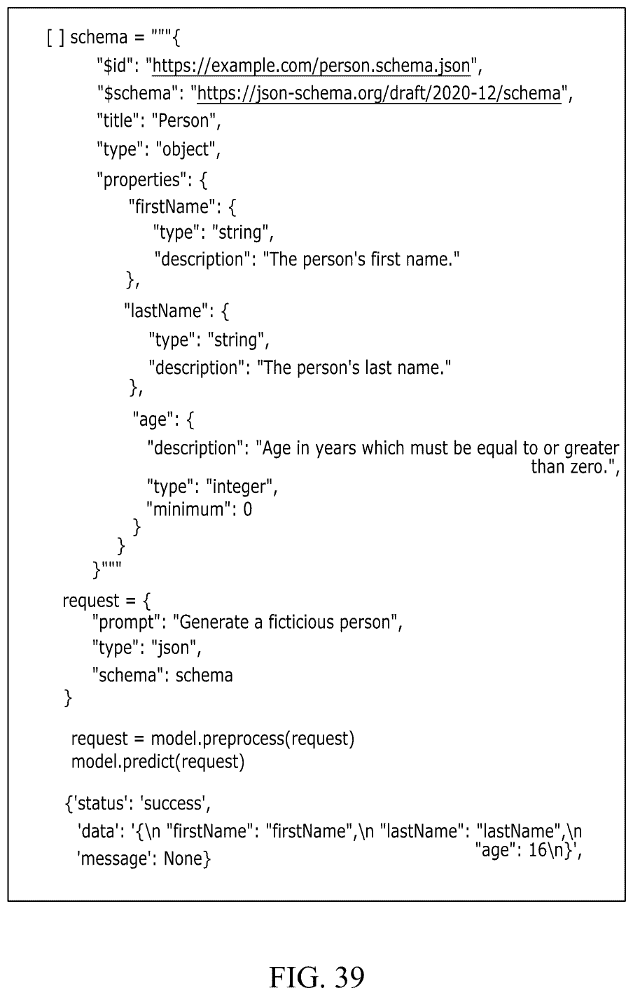

FIG. 39 illustrates an exemplary user-provided JSON Schema defining the desired format for the model's output, according to an aspect.

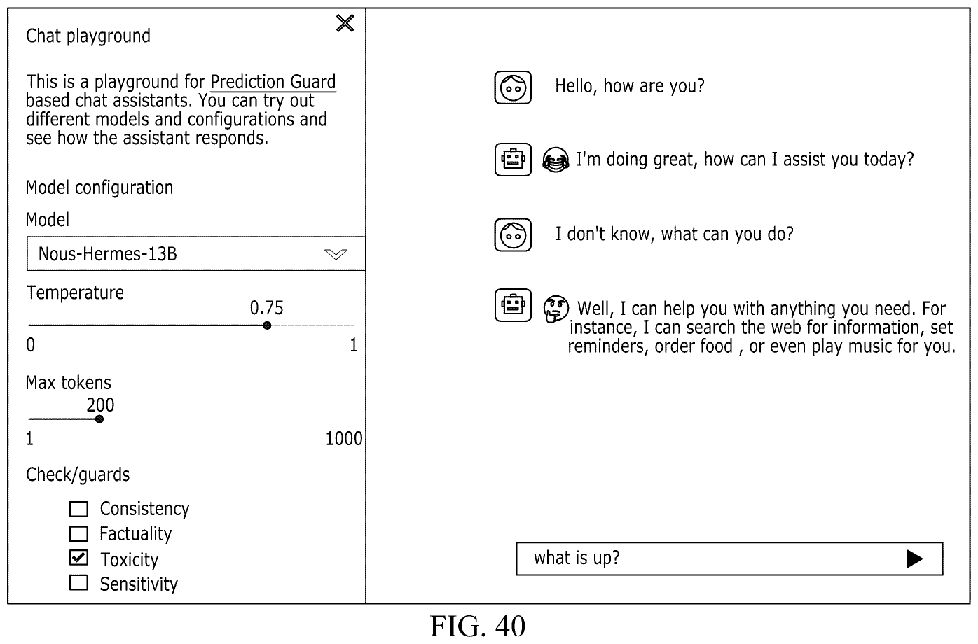

FIG. 40 presents an exemplary graphical user interface of the “Chat Playground” with enabled model selection, a defined number of tokens, and activated toxicity safeguard, all available for user interaction, according to an aspect.

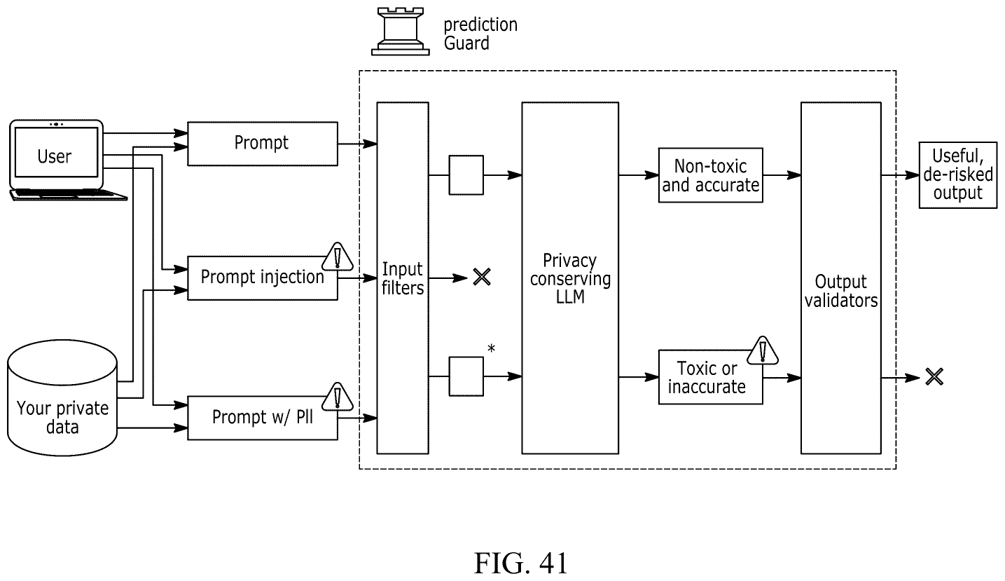

FIG. 41 illustrates a block flow diagram of a process from the entry of a user prompt to an output of the prompt from an LLM using the techniques provided herein, according to an aspect. For example, an initially-provided prompt may be filtered for Personally Identifying Information (PII), prompt injection vulnerabilities, intellectual property that should be kept private. The filtered prompt may be provided to a privacy-conserving LLM, and any initial outputs from the privacy-conserving LLM may be filtered for any toxic or inaccurate content, before providing filtered output to the user. Advantageously the user may be provided with useful, de-risked output.

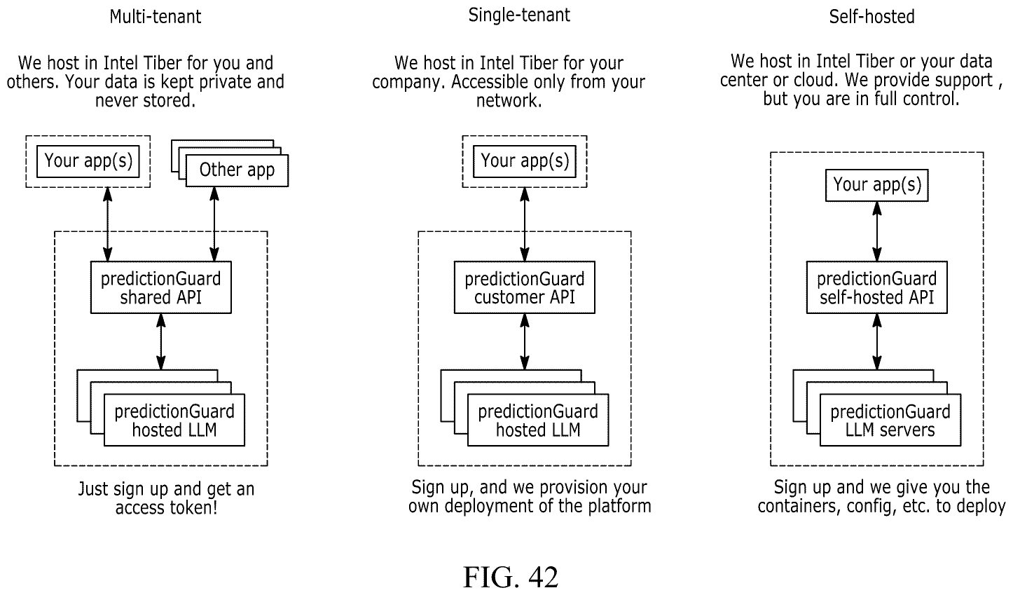

FIG. 42 illustrates several examples of possible ways to host an LLM and API using the techniques provided herein, according to an aspect. For instance, in a multi-tenant example, multiple applications from multiple users may access an API for an externally-hosted LLM. In a single-tenant example, only a single user (i.e., an individual, or a single entity) may access an API for an externally-hosted LLM. The API may only be accessible from the single user's network. Furthermore, in a self-hosted example, the user may host the API and LLM locally. In every case, each user's data is kept private and never stored or shared with other users.

### Further Information

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of ordinary skill in the art will appreciate still additional alternative structural and functional designs for the methods and systems described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

We claim:

1. A computer-implemented method for controlled and validated interactions with one or more predictive language models, the computer-implemented method comprising:
receiving, via one or more processors, user input including a text prompt string;
processing, via the one or more processors, the text prompt string to generate a sanitized text prompt string;
receiving, via the one or more processors, a text output string corresponding to processing of the sanitized text prompt string using the one or more predictive language models;
processing, via the one or more processors, the text output string to generate a sanitized text output string; and
causing, via the one or more processors, the sanitized text output string to be transmitted via an electronic network.

2. The computer-implemented method of claim 1, further comprising aligning, via the one or more processors, one on more outputs with a user-provided knowledge base, wherein the user-provided knowledge base comprises, historical customer interactions, product preferences, and feedback, serves as reference data to which model output must align with to ensure output consistency; and
adjusting, via the one or more processors, one or more parameters of the one or more predictive language models using retrieval augmentation generation or recurrent binary embedding to enhance model performance by adjusting model parameters to ensure consistent outputs with the user-provided knowledge base.

3. The computer-implemented method of claim 1, wherein processing the text output string to generate a sanitized text output string includes:
applying type and structure constraints to outputs of the one or more predictive language models to ensure conformity;
identifying one or more instances of lack of factuality, toxicity, prohibited type or prohibited structure in the text prompt string;
aligning predictive model outputs with knowledge bases as dictated by a user;
enforcing quality controls on output from the one or more predictive language models;
decoding partial outputs from the one or more predictive language models;
processing type and structure constraints to the outputs of the one or more predictive language models to ensure conformity;
implementing privacy controls by generating an updated user input string through filtering personally identifiable information, sensitive information, intellectual property, or prompt injection vulnerabilities from user input;
exercising arbitrary control over outputs generated by a second of one or more predictive language models, leveraging inputs from a first set of one or more predictive language models; and
regulating a desired factuality, factual consistency, toxicity, and consistency in output generated by the one or more predictive language models.

4. The computer-implemented method of claim 1, wherein receiving the user input including the text prompt string includes determining control or constraint parameters to be paired with the text prompt string when processing the text prompt string to generate the sanitized text prompt string using the one or more predictive language models.

5. The computer-implemented method of claim 1, wherein one or more predictive models are pre-configured and trained with one or more of predefined task templates, special tokens to optimize a performance of the one or more predictive language models with task-specific templates; the computer-implemented method further comprising:
training, via the one or more processors, the one or more predictive language models to extract task-specific information from user input text prompts and subsequently adjusting configurations of the one or more predictive language models;
incorporating, via the one or more processors, task-specific data and feedback during training to create tailored templates for task-specific purposes;
generating, via the one or more processors, task-specific templates by customizing the configurations of the one or more predictive language models with pre-configured prompts tailored to specific tasks with role-based and instruction indicators, variable placeholders, and structuring elements; and
iteratively, via the one or more processors, reconfiguring the configurations of the one or more predictive language models and performance based on user input, control parameters in various tasks including summarization, rephrasing, question answering, sentiment analysis, factual consistency detection, toxicity detection, chat, or machine translation.

6. The computer-implemented method of claim 1, further comprising:
parallel processing, via the one or more processors, for controlling a flow of user input through data processing steps based on detections performed to optimize performance;
implementing, via the one or more processors, user-configurable arbitrary or rule-based quality controls, via an API application;
facilitating, via the one or more processors, concurrent chaining of multiple generative AI or predictive model inferences, enabling an execution of tasks including text classifications, Boolean outputs, rephrasing, summarization, and various quality assessments on outputs of the one or more predictive language models; and
constructing, via the one or more processors, responses for a client application from the API application after applying arbitrary controls in parallel during chaining of multiple generative AI or predictive model inferences, including encompassing error messages, flags, scores, or other relevant information.

7. The computer-implemented method of claim 1, further comprising:
modifying, via the one or more processors, data by removing, obfuscating, encrypting, substituting, or anonymizing specific information before exposing it to predictive models;
implementing, via the one or more processors, a controlled decoder that initiates model generation with a prefix that is initially empty and systematically concatenates or enumerates all tokens from a vocabulary to the prefix; and
masking, via the one or more processors, disallowed tokens with probabilities set at 0.0 by identifying the disallowed tokens with regex or context-free patterns to identify allowable tokens capable of matching a specified pattern;
wherein finite state machines, including deterministic finite automaton or other suitable implementations, govern controlled decoding and state transitions that regulate a token generation process.

8. The computer-implemented method of claim 1, further comprising:
optimizing the one or more predictive language models for a specific hardware type of the one or more processors.

9. A computing system for controlled and validated interactions with one or more predictive language models, comprising:
one or more processors;
one or memories having stored thereon computer-executable instructions that when executed cause the computing system to:
receive user input including a text prompt string;
process the text prompt string to generate a sanitized text prompt string;
receive a text output string corresponding to processing of the sanitized text prompt string using the one or more predictive language models;
process the text output string to generate a sanitized text output string; and
cause the sanitized text output string to be transmitted via an electronic network.

10. The computing system of claim 9, the memories having stored thereon instructions that when executed cause the computing system to: identify sensitive, private, or harmful data in the text prompt string.

11. The computing system of claim 9, the memories having stored thereon instructions that when executed cause the computing system to: align outputs generated by the one or more predictive language models with a user-provided knowledge base.

12. The computing system of claim 9, the memories having stored thereon instructions that when executed cause the computing system to: identify task-specific information from user input text prompts and generate task-specific templates by customizing configurations of the one or more predictive language models with pre-configured prompts tailed to specific tasks with role-based and instruction indicators, variable placeholders, and structuring elements.

13. The computing system of claim 9, the memories having stored thereon instructions that when executed cause the computing system to: facilitate concurrent chaining of multiple generative AI or model inferences, constructing responses for a client application from an API application while applying controls in parallel during chaining of multiple model inferences.

14. The computing system of claim 9, the memories having stored thereon instructions that when executed cause the computing system to: modify data before exposing it to the one or more predictive language models and implement a controlled decoder governed by finite state machines for token generation.

15. The computing system of claim 9, the memories having stored thereon instructions that when executed cause the computing system to: receive the user input and pair it with the text prompt string when processing the text prompt string to generate the sanitized text prompt string using the one or more predictive language models.

16. The computing system of claim 9, wherein the one or more predictive language models are optimized for a specific hardware type of the one or more processors.

17. A non-transitory computer readable medium having stored thereon computer-executable instructions that when executed cause a computer to:
receive user input including a text prompt string;
process the text prompt string to generate a sanitized text prompt string;
receive a text output string corresponding to processing of the sanitized text prompt string using one or more predictive language models;
process the text output string to generate a sanitized text output string; and
cause the sanitized text output string to be transmitted via an electronic network.

18. The non-transitory computer readable medium of claim 17, wherein the computer-executable instructions, when executed by the computer, further cause the computer to: identify sensitive, private, or harmful data in the text prompt string.

19. The non-transitory computer readable medium of claim 17, wherein the computer-executable instructions, when executed by the computer, further cause the computer to: align outputs generated by the one or more predictive language models with a user-provided knowledge base.

20. The non-transitory computer readable medium of claim 17, wherein the computer-executable instructions, when executed by the computer, further cause the computer to: identify task-specific information from user input text prompts and generate task-specific templates by customizing configurations of the one or more predictive language models with pre-configured prompts tailed to specific tasks with role-based and instruction indicators, variable placeholders, and structuring elements.
